(19) United States
(12) Patent Application Publication
(10) Pub. No.: US 2025/0273228 A1
(43) Pub. Date: Aug. 28, 2025

(54) Systems and Methods for Enhancing Auditory Attention Decoding Using Spatial Cues

(71) Applicant: The Trustees of Columbia University in the City of New York, New York, NY (US)

(72) Inventors: Vishal CHOUDHARI, New York, NY (US); Cong HAN, New York, NY (US); Nima MESGARANI, New York, NY (US)

(73) Assignee: The Trustees of Columbia University in the City of New York, New York, NY (US)

(21) Appl. No.: 19/198,723

(22) Filed: May 5, 2025

Related U.S. Application Data
(63) Continuation-in-part of application No. PCT/US2023/036705, filed on Nov. 2, 2023.
(60) Provisional application No. 63/528,472, filed on Jul. 24, 2023.
(60) Provisional application No. 63/468,594, filed on May 24, 2023.
(60) Provisional application No. 63/423,917, filed on Nov. 9, 2022.
(60) Provisional application No. 63/422,403, filed on Nov. 3, 2022.

(51) Int. Cl. G10L 21/0272; G06N 3/0455; G10L 25/30

(52) U.S. Cl. CPC G10L 21/0272; G06N 3/0455; G10L 25/30

(57) ABSTRACT

Disclosed are systems, methods, and other implementations, including a method for sound processing that includes obtaining, by a device (e.g., a hearing device), sound signals from two or more sound sources in an acoustic scene in which a person is located, and applying speech-separation processing to the sound signals from the two or more sound sources to derive a plurality of separated signals that each contains signals corresponding to different groups of the two or more sound sources, with the two or more sound sources being associated with spatial information. The method further includes obtaining neural signals for the person, the neural signals being indicative of one of the two or more sound sources the person is attentive to, and processing one or more of the plurality of separated signals selected based on the obtained neural signals, the plurality of separated signals, and the spatial information.

### CROSS-REFERENCE TO RELATED APPLICATIONS

This application is a continuation-in-part (CIP) application of, and claims priority to, International Application No. PCT/US2023/036705, entitled “Systems and Methods for Enhancing Auditory Attention Decoding Using Spatial Cues” and filed Nov. 2, 2023, which in turn claims the benefit of, and priority to, U.S. Provisional Application Nos. 63/422,403 filed Nov. 3, 2022, 63/423,917 filed Nov. 9, 2022, 63/468,594 filed May 24, 2023, and 63/528,472 filed Jul. 24, 2023, all of which are entitled “SYSTEMS AND METHODS FOR ENHANCING AUDITORY ATTENTION DECODING USING SPATIAL CUES,” the contents of all of which are incorporated herein by reference in their entirety.

### STATEMENT REGARDING FEDERALLY SPONSORED RESEARCH

This invention was made with government support under DC014279 awarded by the National Institutes of Health. The government has certain rights in the invention.

### BACKGROUND

Speech communication in multi-talker environments is a challenging task. While people with normal hearing can selectively focus on a single talker of their interest in such complex settings, hearing-impaired listeners have trouble in selectively attending to a single talker in the presence of other interfering talkers. Conventional hearing aids can identify and suppress many background noises, but cannot selectively enhance the attended talker's speech without first knowing which talker out of many is the one to whom the listener wants to listen. It is therefore critical for a hearing aid to be able to automatically distinguish between attended and unattended talkers to selectively enhance the attended talker's speech.

### SUMMARY

The present disclosure is directed to implementations for a proposed auditory attention decoding (AAD) framework to handle moving talkers and background noise. The proposed framework is implemented, in some embodiments, using binaural techniques to allow immersive augmented hearing. A proposed new cognitively-controlled hearing aid can detect the attended speaker more accurately, improve speech intelligibility, and enable the perception of the relative location of moving speakers in complex sound environments. The proposed AAD framework handles moving speakers and retain binaural cues of attended talker. The proposed framework leverages the trajectories of moving speakers to help improve auditory attention decoding performance. In some embodiments, implementations of the proposed framework can be used in virtual and augmented reality (AR/VR) applications which value an immersive aspect of the real environment.

The proposed frameworks implement two important features:
1) Binaural Speech Separation System-a deep learning-based binaural speech separation framework that separates a binaural mixture of speech streams of two or more moving talkers into their individual speech streams while also preserving spatial cues (e.g., interaural time and level differences). This allows the model to also estimate the trajectories of the moving talkers in the acoustic scene. Such trajectories correlate to the locations of the attended-to and unattended-to talkers. In some embodiments, the framework also suppresses background noise if present in the mixture.
2) Auditory Attention Decoding System: A system that takes as input the separated binaural speech streams and motion trajectories of talkers (yielded by the speech separation model) and neural data (whether obtained through invasive means or otherwise) of a subject wearing a cognitively-controlled hearing aid. The framework implements, in some embodiments, a subject-specific canonical correlation analysis (CCA) model that uses the above inputs and predicts the attended talker. The system can continue enhancing audio of a particular talker, or other talkers in the vicinity, based on that talker's trajectory. The system output can then be used to dynamically enhance the speech of the attended talker while also retaining their spatial cues. In some embodiments, spatiotemporal filters were trained to reconstruct the spectrograms and the trajectories of the attended and unattended talkers from the neural recordings. These reconstructions can then be compared with the spectrograms and trajectories yielded by the binaural speech separation processes/algorithms to determine the attended and unattended talkers.

Implementations of the proposed framework may also include a closed-loop mechanism to continually modulate the amplitude levels of the speech signals being processed in response to changing neural activity of the listener. In some embodiments, the proposed framework may perform auditory attention decoding by reconstructing an estimated speech envelope based on the listener's neural signals that are compared to the speech envelopes for the separated sound (speech) signals. The reconstruction of the estimated speech envelope may be based on low and high frequency bands of the measured neural signals. In some embodiments, the auditory attention decoding implementations described herein may also be based on acquired gaze and/or eye-tracking information, smartphone apps that help select target talkers to enhance, etc.

Thus, in some variations, a method for sound processing is provided that includes obtaining, by a device (e.g., a hearing device), sound signals from two or more sound sources in an acoustic scene in which a person is located, and applying, by the device, speech-separation processing to the sound signals from the two or more sound sources to derive a plurality of separated signals that each contains signals corresponding to different groups of the two or more sound sources, with the two or more sound sources being associated with spatial information. The method further includes obtaining, by the device, neural signals for the person, the neural signals being indicative of one of the two or more sound sources the person is attentive to, and processing one or more of the plurality of separated signals selected based on the obtained neural signals, the plurality of separated signals, and the spatial information.

Embodiments of the method may include at least some of the features described in the present disclosure, including one or more of the following features.

Applying the speech separation processing may include separating the sound signals according to a time-domain audio separation network approach implemented with an encoder-decoder architecture.

Separating the sound signals may include processing two or more channels of mixed sound signals produced by the two or more sound sources by respective linear encoder transforms to produce resultant 2-D representations of the mixed sound signals, filtering the resultant 2-D representations of the mixed sound signals and a representation of the spatial information using a series of temporal convolutional network (TCN) blocks to estimate multiplicative masks, applying the estimated multiplicative masks to the resultant 2-D representations of the mixed signals to derive masked representations of separated sound signals for the two or more channels, and filtering the masked representations of the separated sound signals using a linear decoder transform to derive separated waveform representations for different groups of talkers from the two or more sound sources.

The series of temporal convolutional network (TCN) blocks may include multiple repeated stacks that each may include one or more 1-D convolutional blocks.

The method may further include performing post-separation enhancement filtering to suppress noisy features, including processing the mixed sound signals and the separated sound signals with respective linear encoder transforms to produce resultant 2-D post-enhancement representations, filtering the resultant 2-D post enhancement representations using a series of post-enhancement temporal convolutional network (TCN) blocks to estimate post-enhancement multiplicative masks, applying the estimated post-enhancement multiplicative masks to the resultant 2-D representations of the mixed sound signals to derive masked representations for the two or more channels, summing the masked representations for the two or more channels to obtain a summed masked representation, and filtering the summed masked representation using a linear decoder transform.

The method may further include determining the spatial information associated with the two or more sound sources.

Determining the spatial information associated with the two or more sound sources may include deriving sound-based estimated trajectories of the two or more sound sources in the acoustic scene.

Determining the spatial information may include deriving one or more of, for example, inter-channel phase differences (IPDs) between a first sound signal captured at a first microphone for one ear of the person and a second sound signal captured at a second microphone for another ear of the person, and/or an inter-channel level differences (ILD's) between the first sound signal and the second sound signal.

Processing one or more of the plurality of separated signals may include performing canonical correlation analysis based on the neural signal representations, estimated trajectory representations of the two or more sound sources, and the plurality of separated signals, to identify an attended speaker.

Performing the canonical correlation analysis may include applying a machine learning canonical correlation analysis model to machine learning model input data derived from the neural signal representations, the estimated trajectory representations, and the plurality of separated signals.

Obtaining the neural signals for the person may include obtaining the neural signals according to one or more of, for example, electrocorticography (ECoG) recordings, invasive intracranial electroencephalography (iEEG) recordings, non-invasive electroencephalography (EEG) recordings, functional near-infrared spectroscopy (fNIRS) recordings, minimally-invasive neural recordings, ear electroencephalography (EEG) recordings, recordings captured with stentrodes, and/or recordings captured with subdural or brain-implanted electrodes.

Processing one or more of the plurality of separated signals may include performing one or more of, for example, amplifying the at least the one of the plurality of separated signals, and/or attenuating at least another of the plurality of separated signals.

Processing one or more of the plurality of separated signals can further include deriving an estimated speech envelope from a low frequency band and a high frequency band of the neural signals, with the low frequency band and the high frequency band being non-contiguous, and selecting the one of the plurality of separated signals based on a comparison of the estimated speech envelope to respective speech envelopes derived for the plurality of separated signals.

Deriving the estimated speech envelope may include applying a speech envelope reconstruction machine learning system, trained to predict speech envelopes based on neural signal frequency band inputs, to the low frequency band and the high frequency band of the obtained neural signals.

Processing one or more of the plurality of separated signals may include performing closed-loop processing on the one of the plurality of separated signals (e.g., to enhance one of the separated signals) and the neural signals to track attention of the person by continually modulating amplitudes of each of the plurality of separated signals based on the neural signals obtained at a first time instance to cause a change to the respective amplitudes of each of the plurality of separated sound signals that cause a resultant change, at a second time instance, to subsequent neural signals for the person to allow real-time attention switching by the person.

Processing one or more of the plurality of separated signals can include performing auditory attention decoding based on the neural signal representations, estimated trajectory representations of the two or more sound sources, and the plurality of separated signals, to identify an attended speaker.

In some variations, a sound processing system may include at least one microphone to obtain sound signals from two or more sound sources in an acoustic scene in which a person is located, one or more neural sensors to obtain neural signals for the person, with the neural signals being indicative of one of the two or more sound sources the person is attentive to, and a controller coupled to the at least one microphone and the one or more neural sensors. The controller is configured to apply speech-separation processing to the sound signals from the two or more sound sources to derive a plurality of separated signals that each contains signals corresponding to different groups of the two or more sound sources, with the plurality of separated signals being associated with spatial information, and process one or more (and in some situations all) of the plurality of separated signals selected based on the obtained neural signals, the plurality of separated signal, and the spatial information.

In some variations, a non-transitory computer readable media is provided that includes computer instructions executable on a processor-based device to obtain sound signals from two or more sound sources in an acoustic scene in which a person is located, apply speech-separation processing to the sound signals from the two or more sound sources to derive a plurality of separated signals that each contains signals corresponding to different groups of the two or more sound sources, with the two or more sound sources being associated with spatial information, obtain neural signals for the person, the neural signals being indicative of one of the two or more sound sources the person is attentive to, and process one or more of the plurality of separated signals selected based on the obtained neural signals, the plurality of separated signals, and the spatial information.

Embodiments of the system and the computer readable media may include at least some of the features described in the present disclosure, including at least some of the features described above in relation to the method.

Other features and advantages of the invention are apparent from the following description, and from the claims.

### BRIEF DESCRIPTION OF THE DRAWINGS

These and other aspects will now be described in detail with reference to the following drawings.

FIG. 1 includes diagrams of the subsystems constituting a proposed framework for a binaural brain-controlled hearing device.

FIG. 2 is a block diagram of an example TasNet system to separate a combined speech signal.

FIG. 3 is a schematic diagram of an example convolutional TasNet system implementation to separate a combined speech signal.

FIG. 4 includes a diagram of an experimental paradigm to test the framework of FIG. 1.

FIG. 5 includes graphs illustrating performance results of the proposed framework of FIG. 1.

FIG. 6 includes graphs illustrating experimental results obtained from a trial conducted for one of the subjects who, based on behavioral responses, was initially attending to the cued conversation and then later attended to the uncued conversation.

FIG. 7 includes graphs summarizing the performance results of the proposed framework during a talker transition event.

FIG. 8 includes graphs summarizing subjective performance evaluation results for the proposed framework.

FIG. 9 includes graphs summarizing objective performance evaluation results for the proposed framework.

FIG. 10 is a transition probability matrix for a trajectory generation process with a first order Markov chain used in the testing and evaluation of the proposed framework.

FIG. 11 is a flowchart of an example procedure for sound processing.

FIG. 12 is a diagram of an experimental set up to test a system that includes a real-time closed-loop auditory attention decoding (AAD) implementation.

FIG. 13 includes a diagram showing the different electrode coverages for participants using the system of FIG. 12.

FIG. 14 includes a graph illustrating the effect the decoding window size on performance of the AAD process implemented by the system of FIG. 12.

FIG. 15 is a diagram illustrating the auditory attention decoding accuracy of individual electrodes used with the system of FIG. 12.

FIG. 16 includes a graph illustrating accuracy improvement as additional electrodes are incorporated into the implementation of the system of FIG. 12.

FIG. 17 includes a diagram of an experimental set up to evaluate the effect of real-time closed-loop auditory attention decoding, and graphs illustrating the experimental results.

FIG. 18 includes a diagram of an experimental set up to evaluate the effect of real-time closed-loop auditory attention decoding (AAD) on instructed attention switching, and graphs illustrating the experimental results.

FIG. 19 includes a diagram of an experimental set up to evaluate the effect of real-time closed-loop auditory attention decoding (AAD) on self-initiated attention switching, and graphs illustrating the experimental results.

FIG. 20 includes graphs with evaluation results of real-time closed-loop auditory attention decoding (AAD) by individuals with hearing impairment.

Like reference symbols in the various drawings indicate like elements.

### DETAILED DESCRIPTION

The present disclosure is directed to implementations for a proposed new auditory attention decoding (AAD) framework to handle moving talkers and background noise. The proposed AAD framework is combined with a novel binaural speech separation process which separates the speech streams of the talkers while preserving information about their locations. Testing and evaluation of the implemented framework (both subjective and objective evaluations) showed enhanced intelligibility of the desired conversation and preserved spatial cues vital for naturalistic listening.

The human brain has been shown to encode a selective representation of the talker to whom attention is directed in a multi-talker setting. This allows for using neural signals to identify the attended talker, a technique known as auditory attention decoding (AAD). In parallel, the problem of automatic speech separation has seen significant progress in recent years. Speech separation attempts to solve the problem of separating mixtures of talker streams (captured by one or more microphones) into their individual clean streams. Auditory attention decoding can be combined with speech separation techniques to enable brain-controlled hearing devices. The automatic speech separation isolates individual talkers from a mixture of talkers in an acoustic scene while the auditory attention decoding algorithm determines to which talker attention is directed. The attended talker can then be enhanced relative to the background to assist the user of the brain-controlled hearing device.

The ability to localize talkers in space as they move is important for natural listening. Therefore, a brain-controlled hearing device needs binaural speech separation processes that can separate talker speech streams as they move in space while preserving the spatial cues (e.g., through interaural time and level differences) of each talker in the acoustic scene for the listener. This would allow for estimating talker trajectory as a function of time. It has also been shown that the human auditory cortex encodes the location of the attended talker. Therefore, auditory attention decoding techniques can potentially also utilize the estimated trajectories of the moving talkers in addition to their spectral speech information to determine the attended talker. A challenge in auditory attention decoding studies is that it is difficult to know with a high degree of temporal resolution to which talker a subject in the experimental study is actually attending. Oftentimes, it is assumed that the subject always attends to the cued (to-be-attended) conversation throughout the duration of the experiment while the subject might occasionally be attending to the uncued (to-be-unattended conversation). This results in mislabeling of data for training and evaluation which in turn leads to underreporting of performance of AAD algorithms. It is therefore important to have a behavioral measure in the experiment paradigm that can help determine and account for which talker a subject might be attending to with a high temporal resolution.

The proposed framework seeks to address the above challenges. First, the proposed framework is based on a relatively complex and more realistic stimuli in the experiments conducted. The stimuli used in the testing and evaluation conducted included two independent conversations moving in space with separate and independent trajectories. Turn-takings took place among the talkers in these conversations and the subjects were cued to attend to one of the two conversations. These conversations also took place in the presence of natural background noise. Second, to determine which conversation a subject might be attending to, repeated words were placed throughout the to-be-attended and to-be unattended conversation streams. The subjects were instructed to press a button upon hearing a repeated word in the conversation stream being followed. Third, to deal with complex acoustic scene settings with moving talkers and background noise, the proposed framework implements a brain-controlled hearing device that uses auditory attention decoding with a novel binaural speech separation approach that can preserve the spatial location of the talkers. The proposed system enhances speech intelligibility and facilitates conversation tracking while maintaining spatial cues and voice quality in challenging acoustic environments, all of which are necessary for usage of brain-controlled hearing devices in realistic listening environments.

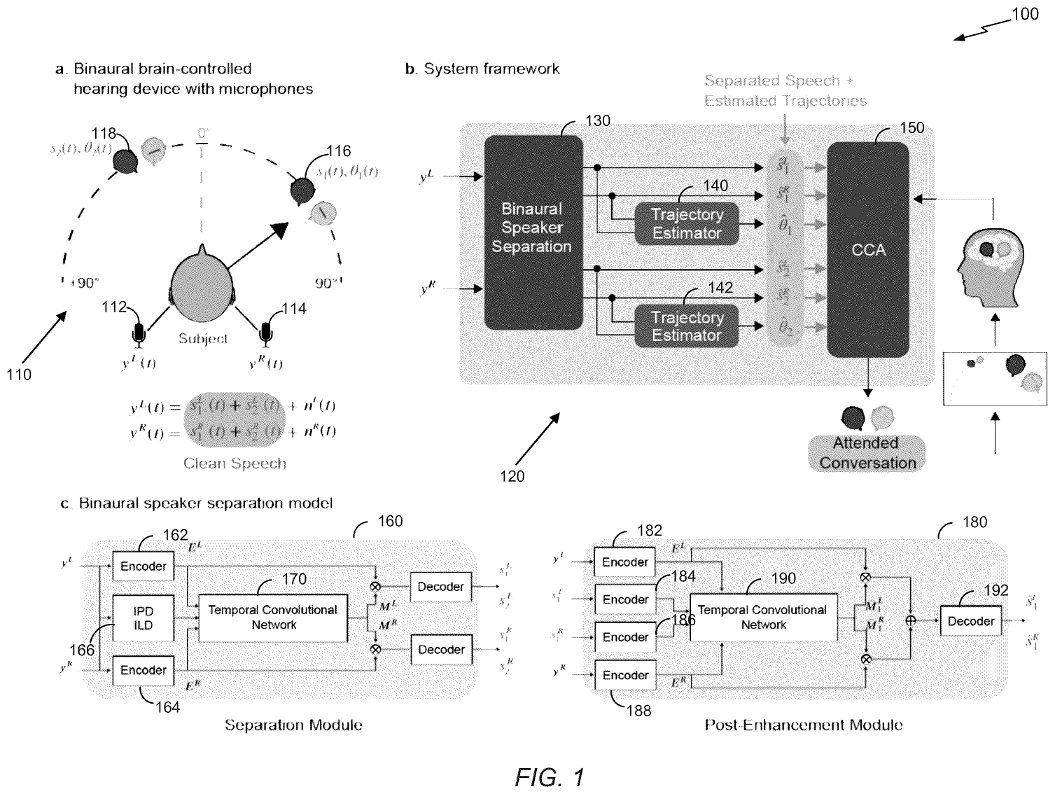

With reference to FIG. 1, diagrams of the different subsystems constituting a proposed framework 100 for a binaural brain-controlled hearing device are shown. Brain-controlled hearing devices need to combine a speech separation model along with auditory attention decoding to determine and enhance the attended talker. Performing AAD requires having access to individual speech streams and trajectories of every talker in the acoustic scene with which neural representations can be compared to determine the attended talker. The proposed framework for a binaural brain-controlled hearing device assumes that there are at least two single-channel microphones, one on the left ear and the other on the right ear. These microphones capture the left and right components of the sounds arriving at the ears of the wearer. The system framework makes use of a deep learning-based binaural speech separation model that separates a binaural mixture of speech streams of two moving talkers (recorded by the binaural microphones) into their individual speech streams while also preserving their spatial cues (e.g., interaural time and level differences). As spatial cues are preserved in the separated speech streams of the talkers, the model is also able to estimate the trajectories of the moving talkers in the acoustic scene. Auditory attention decoding is enabled by performing, for example, canonical correlation analysis which uses the wearer's neural data and the talkers' separated speech and estimated trajectory streams to determine and enhance the attended talker. Alternatively and/or additionally, in some embodiments, identifying the attended talker may be performed using a machine learning implementation for identifying the attended talker, or performing different types of analysis using the neural signals of the listener, the audio signals produced by the speakers, and the positioning/trajectory information.

More particularly, as shown in the top left diagram 110, the framework typically includes two microphones (also referred to as transducers) 112 and 114, one each on the left and the right ears. The microphones separately capture the left and the right mixtures of sound sources arriving at the ears. The left microphone 112 captures an input signal y^{L}(t) which includes the sum of the left-captured component of audio signal s₁(t) produced by a speaker 116 (marked as speaker s1) and the left-captured component of the audio signal s₂(t) produced by the speaker 118 (marked as speaker s2). Similarly, the right microphone 114 captures an input signal y^{R}(t) which includes the sum of the right-captured component of audio signal s₁(t) produced by a speaker 116 and the right-captured component of the audio signal s₂(t) produced by the speaker 118. As illustrated in the diagram 110, each of the binaural devices also captures a corresponding noise component (annotated n^{L}(t) and n^{R}(t)).

The captured signal y^{L}(t) and y^{R}(t) are next processed by a processing subsystem 120 depicted in the top right diagram 120 of FIG. 1. The subsystem 120 includes a binaural speaker separation module 130 which receives the captured input signals from the microphones 112 and 114 and binaurally separates the speech streams. The subsystem 120 is also configured to estimate the trajectories of the speakers using the trajectory estimators 140 and 142. As illustrated. The speaker separation module 130 and the trajectory estimator 140 (which may be implemented according to any suitable technique or approach, including algorithmically, through machine learning, etc.) produce the estimated left and right audio component for s₁, along with the estimated locations of the first speaker (namely, ŝ₁^{L}, ŝ₁^{R}, \hat{θ}₁). The speaker separation module 130 and the trajectory estimator 142 produce the estimated left and right audio component for s₂, along with the estimated locations of the second speaker (namely, ŝ₁^{L}, ŝ₂^{R}, \hat{θ}₂). These outputs are used in combination with the wearer's neural data to decode the attended talker. For example, the estimated trajectory provides information on changes in the spatial positions of the audio source(s) the listener is attending to, which facilitates the correct tracking of the correct group of the sound source(s) to isolate from the audio mixture. As will be discussed in greater detail below, in some embodiments, the attention decoding is performed using canonical correlation analysis unit 150.

The binaural speaker separation model 130 includes an initial separation module 160 (an example embodiment of which is depicted in the bottom left diagram of FIG. 1) whose outputs are further improved by a post-enhancement module 180 (an example embodiment of which is as depicted in the bottom right diagram). Both the illustrated example embodiments of the initial (i.e., upstream) separation modules 160 and the post enhancement module 180 may be implemented under a Time-domain Audio Separation Network (TasNet) approach (details of example TasNet implementations are discussed, for example, at U.S. Pat. No. 11,373,672, entitled “Systems and methods for speech separation and neural decoding of attentional selection in multi-speaker environments,” the content of which is incorporated herein by reference in its entirely).

Briefly, TasNet is used to directly model a signal in the time-domain using an encoder-decoder framework, and to perform source separation on (typically) nonnegative encoder outputs. Such implementations remove the frequency decomposition stage and reduce the separation problem to estimation of source masks on encoder outputs which is then synthesized by the decoder. These implementations generally outperform state-of-the-art causal and non-causal speech separation systems (such as STFT-based systems), reduce the computational cost of speech separation, and reduce the minimum required latency of the output. This makes TasNet suitable for applications where low-power, real-time implementation is desirable, such as in hearable and telecommunication devices.

One example implementation of the TasNet-based framework uses deep Long-Short Term Memory Network (LSTM). A mixture waveform (i.e., the mixed signal resulting from the combining of speech signals produced by multiple speakers) is divided into non-overlapped segments, and each segment is represented as a weighted sum of a set of basis signals that is optimized automatically by the network, with (in some embodiments) the constraint that the weights be nonnegative. The time-domain signal can then be represented by a weight matrix, reformulating the waveform separation problem into estimating the weight matrices that correspond to different sources given the weight matrix of the mixture. A deep long-short term memory network (LSTM) is configured for this process. The synthesis of the sources signals is done by calculating the weighted sum of the bases with the estimated source weight matrices. Without the need for calculating short-time Fourier transform (STFT) and its inverse, this system has much shorter latency than STFT-based systems, where a spectrogram is typically taken as the input and a time-frequency mask as the output.

Another example implementation of the TasNet-based framework uses a convolution encoder approach (this approach is referred to as “convolutional TasNet”). The convolutional encoder creates a representation of the signal that is optimized for extracting individual speakers. Speaker extraction is achieved by applying a weighting function (mask) to the encoder output. The modified encoder representation is then inverted to the sound waveform using a linear decoder. The masks are found using a temporal convolution network comprising of dilated convolutions, which allow the network to model the long-term dependencies of the speech signal. This end-to-end speech separation approach provides good performance in terms of separating speakers in mixed audio. In various embodiments, a convolutional TasNet system may use a stacked dilated 1-D convolutional networks. This approach is motivated by the success of temporal convolutional network (TCN) models which allow parallel processing on consecutive frames or segments to speed up the separation process. To decrease the number of parameters and the computational complexity of the system, the convolution operation may be replaced with depth-wise separable convolution. Such a configuration provides high separation accuracy. Each layer in a TCN may contain a 1-D convolution block with increasing dilation factors. The dilation factors increase exponentially to ensure a sufficiently large temporal context window to take advantage of the long-range dependencies of the speech signal. In Conv-TasNet implementations, M convolution blocks with dilation factors 1, 2, 4, . . . , 2M−1 are repeated R times. The output of the last block in the last repeat is then passed to a 1×1 convolutional layer with N×C filters followed (in some examples) by a Softmax activation function to estimate C mask vectors for each of the C target sources. The input to each block may be zero padded to ensure the output length is the same as the input.

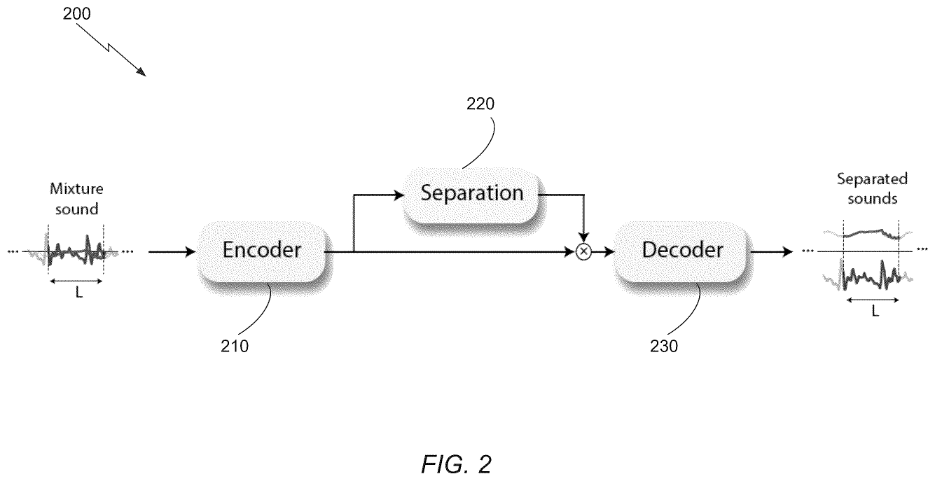

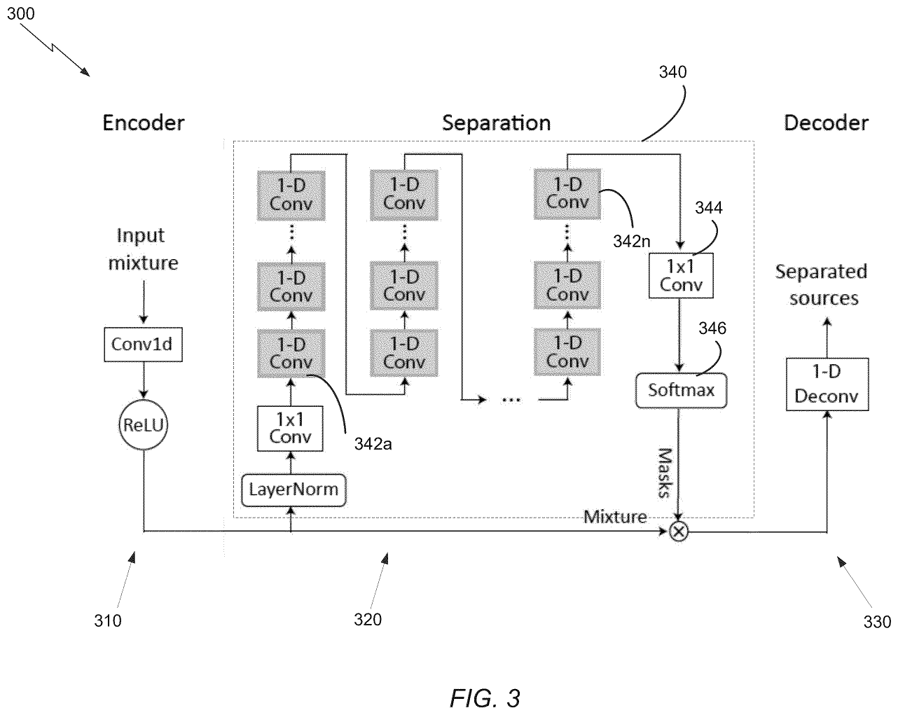

An example architecture of the convolutional TasNet framework (which was the architecture implemented for testing and evaluation of the speech processing described herein) is shown in FIGS. 2 and 3. FIG. 2 is a block diagram of an example convolutional TasNet system 200 to separate a combined speech signal(s) corresponding to multiple speakers. The fully-convolutional time-domain audio separation network (Conv-TasNet) includes three processing stages, namely, an encoder 210 (which may be configured to perform some pre-processing, such as dividing the combined signal into separate segments and/or normalize those segments), a separation unit 220, and a decoder 230. First, the encoder 210 is used to transform short segments of the mixture waveform into their corresponding representations in an intermediate feature space. This representation is then used to estimate a multiplicative function (mask) for each source and for each encoder output at each time step. The source waveforms are then reconstructed by transforming the masked encoder features using a linear decoder module (e.g., of the decoder 230).

More particularly, with further reference to the encoder 210, the problem of single-channel speech separation can be formulated in terms of estimating C sources s₁(t), . . . , s_{c}(t)∈R^{1×T}, given the discrete waveform of the mixture x(t)∈R^{1×T}, where

$$x ( t ) = {\sum }_{i = 1}^{C} {s}_{i} ( t )$$

In time domain audio separation, the aim is to directly estimate sᵢ(t); i=1, . . . , C, from x(t).

Each segment of the input mixture sound with length L, xₖ∈R^{1×L} (hereafter x for simplicity) where k=1, . . . , T/L, is transformed into a nonnegative representation, w∈R^{1×N} by a 1-D convolution operation (the index k is dropped from now on):

$$w = R e L U ( x * U )$$

where U∈R^{N×L} contains N vectors (encoder basis functions) with length L each, and * denotes the convolution operation. ReLU denotes the rectified linear unit activation. The decoder 230 reconstructs the waveform from this representation using a 1-D linear deconvolution operation, which can be defined as a matrix multiplication \hat{x}=wV, where x∈R^{1×L} is the reconstruction of x, and the rows in V∈R^{N×L} are the decoder basis functions, each with length L. In the case of overlapping encoder outputs, the overlapping reconstructed segments are summed together to generate the final reconstructions.

The separation for each frame is performed by estimating C vectors (masks) mᵢ∈R^{1×N}, with i=1, . . . , C, where C is the number of speakers in the mixture that is multiplied by the encoder output w. The mask vectors mᵢ have the constraint that Σᵢ₌₁^{C}mᵢ=1, where 1 is the unit vector in R^{1×N}. The representation of each source, dᵢ∈R^{1×N}, is then calculated by applying the corresponding mask, mi, to the mixture representation w: dᵢ=w□mᵢ.

The waveform of each source ŝᵢ, i=1, . . . , C is then reconstructed by the decoder 230 according to ŝ=diV. The unit summation constraint that is imposed on the masks guarantees that the reconstructed sources add up to the reconstructed mixture \hat{x}=Σᵢ₌₁^{C}ŝᵢ, since Σᵢ₌₁^{C}dᵢ=w□Σᵢ₌₁^{C}mᵢ=w.

FIG. 3 is a schematic diagram of another example system implementation 300, which may be similar to the example system implementation 200 of FIG. 2, and is configured to separate a combined speech signal (resulting from individual speech signals uttered by multiple speakers). FIG. 3 provides details regarding the configuration and structure of the separation module 320 (which may be similar to the separation module 220) implemented as a stacked 1-D dilated convolution blocks 340 (this stacked 1-D dilated configuration is motivated by the temporal convolutional network (TCN)). TCN was proposed as a replacement for recurrent neural networks (RNNs) for various tasks. Each layer in a TCN contains a 1-D convolution block with increasing dilation factors. The dilation factors increase exponentially to ensure a sufficiently large temporal context window to take advantage of the long-range dependencies of the speech signal,

In the Conv-TasNet approach, M convolution blocks 342a-n with dilation factors 1, 2, 4, . . . , 2^{M-1} are repeated R times. The output of the last block in the last repeat is then passed to a 1×1 convolutional layer 344 with N×C filters followed by a Softmax activation function 346 to estimate C mask vectors for each of the C target sources. The input to each block may be zero padded to ensure the output length is the same as the input. To further decrease the number of parameters, a depthwise separable convolution (S-conv(·)) is utilized to replace standard convolution in each convolutional block. Depthwise separable convolution (also referred to as separable convolution) has proven effective in image processing and neural machine translation tasks. The depthwise separable convolution operator involves two consecutive operations, a depthwise convolution (D-conv(·)) followed by a standard convolution with kernel size 1 (pointwise convolution, 1×1-conv(·)):

$$D - conv ( Y , K ) = concat ( {y}_{j} * {k}_{j} ) , j = 1 , … , N S - con v ( Y , K , L ) = D - c o n v ( Y , K ) * L \qquad ( 7 )$$

where Y∈R^{G×M} is the input to the S-conv(·), K∈R^{G×P} is the convolution kernel with size P, yⱼ∈R^{1×M} and kⱼ∈R^{1×P} are the rows of matrices Y and K, respectively, and L∈R^{G×H×1} is the convolution kernel with size 1. In other words, the D-conv(·) operation convolves each row of the input Y with the corresponding row of matrix K, and 1×1-conv(·) is the same as a fully connected linear layer that maps the channel features to a transformed feature space. In comparison with the standard convolution with kernel size \hat{K}∈R^{G×H×P}, depthwise separable convolution only contains G×P+G×H parameters, which decreases the model size by a factor of

$$\frac{H \times P}{H + P} .$$

Turning back to FIG. 1, the binaural separation module takes binaural mixed signals as input and simultaneously separates speech for both left and right channels. Specifically, two linear encoders 162 and 164 transform the two channels of mixed signals y^{L}, y^{R}∈ [symbol] ^{T} (produced by the two or more talkers such as the 116 and 118 talkers) into 2-D representations EL, ER E [symbol] ^{N×H}, respectively, where T represents the waveform length, N represents the number of encoder bases, and H represents the number of time frames (while the example of FIG. 1 uses two channels of mixed signals, in some embodiments additional mixed signal channels may be used). To explicitly exploit spatial information, the encoder outputs, inter-channel phase differences (IPDs) and inter-channel level differences (ILDs), which are concatenated between y^{L} and y^{R}, forming spectro-temporal and spatial-temporal features. The IPDs and ILD's are derived using an IPD/ILD unit 166, illustrated in FIG. 1. These features are passed through a series of temporal convolutional network (TCN) blocks (in a manner similar to that described in relation to FIG. 3), implemented by temporal convolutional network 170, to estimate multiplicative masks, M^{L}, M^{R}∈ [symbol] ^{C×N×H}, where C is the number of speakers. In the testing and evaluation performed, C was pre-fixed to be two (2). The multiplicative masks are then applied to E^{L} and E^{R}, respectively, and a linear decoder transforms the masked representations back to the waveform of individual speaker,

$${\{ {s}_{i}^{L} , {s}_{i}^{R} \}}_{i = 1}^{C} .$$

In various embodiments, the binaural speech separation module was trained using permutation invariant training. Additionally, a constraint that the speaker order be the same for both channels was imposed, allowing the left-and right-channel signals of each individual speaker to be paired directly. The average signal-to-noise ratio (SNR) improvement of the separated speech over the raw mixture was 14.05±4.79 dB.

As noted, the IPD/ILD unit 166 is configured to derive the inter-channel phase differences (IPDs) and inter-channel level differences (ILDs) between the two channels (left and rights) of the hearing apparatus. Although the encoder outputs E^{L} and E^{R} contain both spectral and spatial information, the interaural phase difference (IPD) and interaural level difference (ILD) are determined as additional features to increase speaker distinction when speakers are at different locations. For example, the quantities cos (IPD), sin (IPD), and ILD∈ [symbol] ^{F×H}, may be derived as follows:

$$cos ( I P D ) = cos ( ∠ {Y}^{L} - ∠ {Y}^{R} ) , \qquad a )$$

$$sin ( IP D ) = sin ( ∠ {Y}^{L} - ∠ {Y}^{R} ) , and \qquad b )$$

$$ILD = 10 {log}_{10} ( \vert {Y}^{L} \vert ⌀ \vert {Y}^{R} \vert ) , \qquad c )$$

where Y^{L}, Y^{R}∈ [symbol] ^{F×H} are the STFT output of y^{L}, y^{R}, respectively, F is the number of frequency bins, and [symbol] is element-wise division operation. The hop size for calculating Y^{L} and Y^{R} is the same as that for E^{L} and E^{R} to ensure they have the same number of time frames, even though the window length in the encoder is typically much shorter than that in the STFT. Finally, the cross-domain features are concatenated into [E^{L}, E^{R}, cos (IPD), sin (IPD), ILD]∈ [symbol] ^{(2N+3F)×H} as the input to the temporal convolutional network 170 of the binaural speech separation module 160.

While the TasNet approach has been discussed as the audio separation processes used in the example embodiments for the separation module 160 (and the Post-Enhancement module 180), other types of speech separation approaches may be used. For example, in some embodiments, the various additional speech separation approaches that may be used in conjunction with the proposed framework include a spectrogram-based approach, a deep-attractor network (DANet) approach, an online deep attractor network (ODAN) approach, a neural-signals-to-spectrogram based approach, and others. Details of some of the additional audio separation approaches are described in U.S. Pat. No. 11,373,672, entitled “Systems and methods for speech separation and neural decoding of attentional selection in multi-speaker environments,” the content of which is hereby incorporated by reference in its entirety.

Briefly, in an example spectrogram-based approach, after obtaining the mixed/combined audio signal, a spectrogram of the mixture is obtained, and the spectrogram is fed to each of several deep neural networks (DNNs), each trained to separate a specific speaker from a mixture. At the same time, a user may be attending to one of the speakers. A spectrogram of this speaker is reconstructed from the neural recordings of the user. This reconstruction is then compared with the outputs of each of the DNNs using, for example, a normalized correlation analysis in order to select the appropriate spectrogram, which is then converted into an acoustic waveform and added to the mixture so as to amplify the attended speaker (and/or attenuate the signals corresponding to the non-attended speakers).

Under the DANet approach a deep learning framework for single channel speech separation is configured to create attractor points in high dimensional embedding space of the acoustic signals, which pull together the time-frequency bins corresponding to each source. Attractor points may be created by finding the centroids of the sources in the embedding space, which are subsequently used to determine the similarity of each bin in the mixture to each source. The network is then trained to minimize the reconstruction error of each source by optimizing the embeddings. Under the ODAN approach, source separation is performed by first projecting the mixture spectrogram onto a high-dimensional space where T-F bins belonging to the same source are placed closer together to facilitate their assignment to the corresponding sources. This procedure is performed in multiple steps. First, the mixture magnitude spectrogram, |X(f,t)|, is projected onto a tensor, V(f,t,k), where each time-frequency bin is represented by a vector of length K according to V(f,t,k)=H(|X(f,t)|; θ). H(·) may be implemented, in some examples, using a deep neural network with parameters θ. This representation is referred to as the embedding space.

Other approaches for audio/sound separation may directly use the listener neural signals to construct masks or filters to separate a mixed audio signal into the individual components comprising the mixed signal. In a further example approach, referred to as brain-informed speech separation (BISS), an AAD system (the “brain decoder”) decodes an envelope (or some other representation) of the attended speech using brain signals (EEG or iEEG signals), and uses the decoded envelope (or “hint”) to incorporate that information into a deep-learning-based speech separation process/algorithm to provide information regarding which of the signals in the acoustic scene has to be extracted from a multi-talker speech mixture. The extracted (enhanced) speech of the desired speaker is then amplified and delivered to the user. The brain decoder is configured to reconstruct the speech envelope of the attended speaker from the raw data collected by EEG or iEEG sensors. The decoder may be implemented a spatio-temporal filter that maps the neural recordings to a speech envelope. The mapping may be based on a stimulus reconstruction method which may be learned, for example, using regularized linear regression or a deep neural network model. For both the EEG and iEEG data, a subject-specific linear decoder can be trained on single talker (S-T) data and used to reconstruct speech envelopes on the multi-talker (M-T) data. This approach avoids potential bias introduced by training and testing on the M-T data. A Separation model implemented by the target extraction network may be based on an architecture that only uses 2D convolution structure (but possibly may use other configurations and structures, including a long-short term memory (LSTM) network). The general architecture includes a computational block that fuses a hint signal with the mixture audio, followed by a processing arrangement that includes stacks of convolutional layers. A final block applies an estimated complex mask M to the compressed input mixture spectrogram Yc and inverts the estimated output spectrogram to the time domain. Additional details regarding implementation of the BISS approach for audio separation is provided, for example, in international application No. PCT/US2021/053560, entitled “Systems and methods for brain-informed speech separation,” the content of which is incorporated herein by reference in its entirety.

Turning back to FIG. 1, the binaural post-enhancement module 180 aims to enhance performance in noisy and reverberant environments because post processing stages have shown effectiveness in improving the signal quality. The module takes each pair of the separated stereo sounds (e.g., sᵢ^{L},sᵢ^{R}) and the mixed signals (y^{L} and y^{R}) as inputs. All the encoder outputs (of encoders 182, 184, 186, and 188) are passed through the TCN blocks (arranged in a block 190) to estimate multiplicative masks for separating sources. Unlike the speech separation module that only applies multiplicative masks, which is equivalent to spectral filtering, the speech enhancement module performs both multiplication and summation, equivalent to both spectral and spatial filtering. This is similar to multichannel Wiener filtering. Because the input stereo sound (sᵢ^{L},sᵢ^{R}) contains both spectral and spatial information of the speaker i, the enhancement module essentially performs informed speaker extraction without the need for permutation invariant training. The average SNR improvement of the enhanced speech over the raw mixture was 16.77±4.92 dB in various experimentations performed to evaluate the framework.

As noted, in the example embodiments described herein, binaural speech separation module was trained using permutation invariant training. An example approach for such training uses signal-to-noise ratio (SNR) as an objective function for both the speech separation and enhancement modules. Particularly:

$$S N R ( x , \hat{x} ) = 10 {log}_{10} ( \frac{{‖ x ‖}_{2}^{2}}{{‖ x - \hat{x} ‖}_{2}^{2}} ) ,$$

where x and \hat{x} are the ground truth and estimated waveform, respectively. Because SNR is sensitive to both time shift and power scale of the estimated waveform, it can force the interaural level difference (ILD) and interaural phase difference (IPD) to be preserved in the estimated waveform. Moreover, utterance-level training can be performed on a moving speaker dataset, which encourages the model to leverage spectral and spatial features of speakers in a large context and forces the model to track speakers within the utterance without the need for explicit tracking modules. This approach enables the model to handle moving sources effectively.

speaker localization estimators (implemented through the trajectory estimators 140 and 142 depicted in FIG. 1), producing (e.g., based on the IPD and IDL) estimated relative angles \hat{θ} indicative of the position of a speaker (or speakers) relative to the listener, were also trained using a similar architecture to the enhancement module. The module performs classification of the direction of arrival (DOA) every millisecond. The localizer modules estimate moving trajectories for each moving source. The estimated moving trajectories can be utilized to improve the accuracy of attentional decoding. The average DOA error of the estimated trajectories was 4.20±5.76 degrees.

As indicated, in order to decode the attended talker, in example embodiments, neural signals were compared with speech representations (e.g., spectrograms) and trajectories of talkers using canonical correlation analysis (CCA). CCA is an approach for multivariate analysis that derives relationship between the multidimensional variables. In some embodiments, the CCA operations for the proposed framework may be implemented using a machine learning system.

For the CCA implementations, the stimuli included the inputs of talker spectrograms and trajectories. 20-bin mel spectrogram representations (for resultant separated audio signals), obtained with a window duration of 30 ms and a hop size of 10 ms, were chosen. Audio was downsampled to 16 kHz before mel spectrogram extraction. The mel spectrograms of the left and right channels were concatenated along the bin dimension. All trajectories were upsampled to 100 Hz from 10 Hz to match the sampling rate of the neural data. Trajectories were pooled across all trials and normalized. Spectrograms were also normalized on a bin-by-bin basis. A receptive field size of 500 ms was chosen for neural data and 200 ms for stimuli spectrograms and trajectories. The starting sample of these receptive fields were aligned in time. Time-lagged matrices were then generated individually for neural data, trajectory, and spectrograms.

Principal component analysis (PCA) was applied individually to time-lagged versions of both spectrogram and trajectory. PCA was also applied to the time lagged neural data matrix. The top PCA components accounting for at least 95% of the variance were retained. This was done to reduce the risk of overfitting in CCA. CCA filters were trained to project PCA-reduced versions of the attended stimuli and neural data to maximize their correlation. During inference, the trained filters were used to generate correlations for each talker. The attended talker was decided based on voting by the preferences indicated by the first three canonical correlations.

For trials in which two or more repeated words were detected in the uncued conversation, the corresponding portions (bounded by button press timings) of the cued to-be-attended and uncued to-be-unattended stimuli were swapped before model training and evaluation. For models trained without correction, no such swapping was done based on behavior.

For certain trials where it was evident that the subject was following the uncued conversation (greater than or equal to two repeated words detected in the uncued stream), the “attend” and “unattend” labels were swapped for the conversations in that portion. Subject-wise CCA models were trained, and their performance was evaluated using leave-one-trial-out cross validation, i.e., training on N−1 trials and testing on the windows from the N^{th} trial. During training, the CCA models simultaneously learn forward filters on attended talker's clean speech spectrogram and trajectory, and backward filters on the neural data, such that upon projection with these filters, the neural data and the attended talker stimuli would be maximally correlated. During testing, these learnt filters were applied to the neural data as well as to every talker's speech spectrogram and trajectory. The talker who yielded the highest correlation score (based on voting of the top three canonical correlations) was determined as the attended talker.

In the embodiments of the framework that were implemented and evaluated, the binaural separation, post-enhancement, and localizer modules were all implemented with a causal configuration of TasNet. For the linear encoder and decoder, 96 filters were used with a 4 ms filter length (equivalent to 64 samples at 16 kHz) and 2 ms hop size. Five (5) repeated stacks were used with each having seven (7) 1-D convolutional blocks in the TCN module, resulting in an effective receptive field of approximately 2.5 s. When calculating cos (IPD), sin (IPD), and ILD, the STFT window size was set to 32 ms and the window shift to 2 ms. The binaural separation, post-enhancement, and localizer modules were trained separately. The training batch size was set to 128. An Adam (adaptive moment estimation) optimizer (which based on a stochastic gradient descent optimization approach) was used as the optimizer with an initial learning rate of le-3, which was decayed by 0.98 for every two epochs. Each module was trained for 100 epochs.

For the training and development sets, 24,000 and 2400 9.6-second binaural audio mixtures were generated, respectively. Each mixture comprised two moving speakers and one isotropic background noise. Speech was randomly sampled from the Librispeech dataset. For half of the training data, pairs of trajectories were chosen that spanned uniform distribution (quantified by joint entropy); and for another half of the training data, pairs of trajectories whose average distance difference was smaller than 15 degrees were chosen to enhance the separation model's ability to handle closely spaced moving speakers. Noise from DEMAND dataset was randomly chosen. The SNR, defined as the ratio of the speech mixture in the left channel to the noise, ranged from −2.5 to 15 dB. All sounds were resampled to 16 kHz.

The audio/sound processing framework described herein was tested and evaluated using several experiments that tested different aspects of the performance of the framework. In a first experiment, neural responses from three patients undergoing epilepsy treatment were collected as they performed the task with intracranial electroencephalography (iEEG). Two patients (Subjects 1 and 2) had sEEG depth as well as subdural electrocorticography (ECoG) grid electrodes implanted over the left hemispheres of their brains. The other patient (Subject 3) only had stereo-electroencephalography (sEEG) depth electrodes implanted over their left-brain hemisphere. All subjects had electrode coverage over their left temporal lobe, spanning the auditory cortex. The neural data was processed to extract the envelope of the high gamma band (70-150 Hz) band and was used for the rest of the analysis. Speech-responsive electrodes were determined using t-tests on neural data samples collected during speech v/s silence. S1, S2 and S3 had 17, 34 and 42 speech-responsive electrodes, respectively.

The neural data of participants from NSUH (Subjects 1 and 2) were recorded using Tucker-Davis Technologies (TDT) hardware using a sampling rate of 1526 Hz. The neural data of the participant from CUIMC (Subject 3) was recorded using Natus Quantum hardware using a sampling rate of 1024 Hz. Left and right channels of the audio stimuli played to the participants were also recorded in sync with neural signals to facilitate segmenting of neural data into trials for further offline analysis. The collected neural data was pre-processed and analyzed using MATLAB software (MathWorks). All neural data was first resampled to 1000 Hz and then montaged to a common average reference to reduce recording noise. The neural data was then further downsampled to 400 Hz. Line noise at 60 Hz and its harmonics (up to 180 Hz) were removed using a notch filter. The notch filter was designed using MATLAB's fir2 function and applied using filtfilt with an order of 1000. In order to extract the envelope of the high gamma band (70-150 Hz), the neural data was first filtered with a bank of eight filters, each with a width of 10 Hz, spaced consecutively between 70 Hz and 150 Hz. The envelopes of the outputs of these filters were obtained by computing the absolute value of their Hilbert transform. The final envelope of the high gamma band was obtained by computing the mean of the individual envelopes yielded by the eight filters and further downsampling to 100 Hz. Speech responsive electrodes were determined by comparing neural samples (of the high gamma envelope sampled at 100 Hz) recorded in response to speech with those recorded in response to silence. For each trial, twenty-five (25) samples corresponding to silence were randomly chosen in a [t=−0.4 s to −0.1 s] window, with t=0 s being the onset of speech. Similarly, 25 samples corresponding to speech were drawn from a window [t=0.1 s to 1.6 s]. These samples were accumulated across trials and a t-statistic (between speech and silence samples) was computed for every electrode. Electrodes with a t-statistic above 5 were considered to be speech-responsive and retained for further analysis.

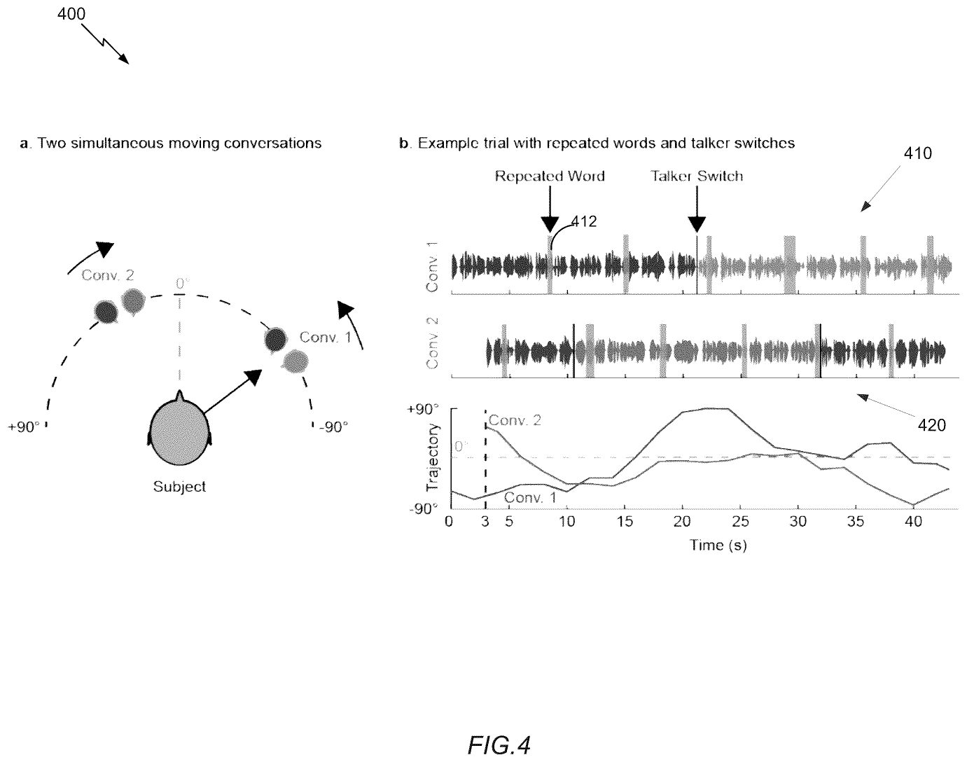

A diagram 400 of an experimental paradigm to test the framework described herein is shown in FIG. 4. Every trial included two concurrent conversations moving independently in the front hemifield of the subject, with each conversation having two distinct talkers taking turns. Repeated words were inserted across the two conversations (as highlighted by the rectangular pulses, e.g., a rectangular pulse 412, in the recorded audio signals). The cued (to-be-attended) conversation had a talker switch at 50% trial time mark whereas the uncued (to-be-unattended) conversation had two talker switches, at 25% and 75% trial time marks. The experiment had a total of 28 multi-talker trials, with the average duration of 44.2 s (standard deviation=2.0 s) each. As shown in the left hand side of FIG. 4, the configuration of the speakers had two concurrent and independent conversations that were spatially separated and continuously moving in the frontal half of the horizontal plane of the subject. The distances of these conversations from the subject were equal and constant throughout the experiment. Both conversations were of equal power (RMS). Talkers were all native American English speakers. Monaural background noise (either “pedestrian” or “speech babble”) was also mixed along with the conversations at a power level of either 9 dB or 12 dB below the power of a conversation stream.

Every trial consisted of four talkers: two for the to-be-attended conversation (say A and B), two for the to-be-unattended conversation (say C and D). The to-be-attended conversation had one turn-taking (talker switch) at the 50% trial time mark whereas the to-be-ignored conversation had two turn-takings: one at the 25% trial time mark and the other at the 75% trial time mark. Thus, the talker in the to-be-attended conversation would transition from A to B and the talker in the to-be-ignored conversation would transition from C to D to back to C. During the experiment, different talkers took turns in these conversations. As shown in FIG. 4, in the to-be-attended conversation 410, a talker switch took place at around 50% trial time mark whereas for the to-be unattended conversation 420, two talker switches took place, one at around 25% trial time mark and the other nearly at the 75% trial time mark.

In order to check which conversation a participant might be attending, repeated words were deliberately inserted in both the to-be-attended and the to-be-ignored conversations. The average time interval between the onsets of two repeated words in a conversation was 7.0 s (standard deviation=1.0 s). Participants were asked to press a button upon hearing a repeated word in the conversation that they were following. The conversation transcripts were force aligned with the audio recordings of the voice actors using the Montreal Forced Aligner tool. The repeated words were inserted in the conversations based on the following criteria:
The number of repeated words to be inserted in a conversation of a trial was determined by dividing the trial duration (in seconds) by 7 and rounding the result.
For every trial, an equal number of repeated words were inserted in the to-be-attended and the to-be-ignored conversations.
A word could be repeated only if its duration was at least 300 ms.
To make repeated words sound smooth and natural, a Hanning window of 30 ms was applied to both sides of the audio segment corresponding to the repeated word.
The audio segment corresponding to a repeated word was also prefixed and postfixed with 200 ms of silence.
The time interval between the onsets of two repeated words in a conversation was constrained to lie between 5.5 s to 9.5 s.
There was always one repeated word whose onset was within 1.5 s post talker switch in the to-be-attended conversation. This was done to check if participants tracked the switch in talkers in the to-be-attended conversation.
The onset of the first repeated word in a trial was constrained to lie between 5-8 s from trial start time. This first repeated word could occur either in the to-be-attended conversation or the to-be-ignored conversation.
The minimum time gap between a repeated word onset in the to-be-attended conversation and a repeated word onset in the to-be-ignored conversation was set to be at least 2.5 s.

This was done to prevent simultaneous overlap of repeated words in the two conversations and to allow for determining which conversation a participant was attending to.

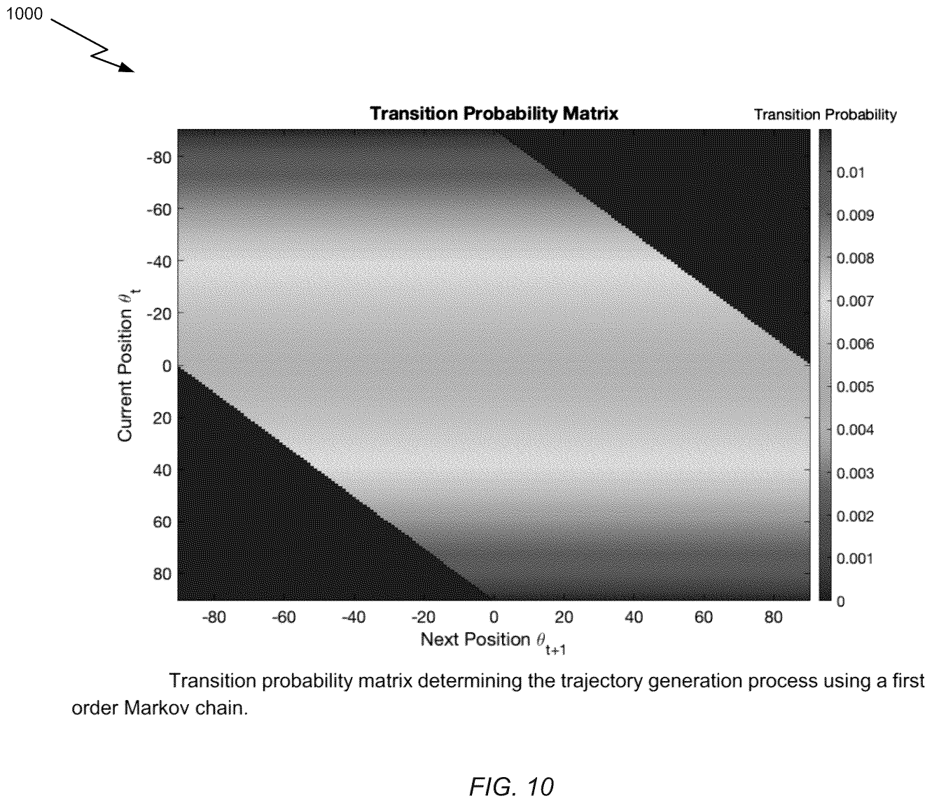

Google Resonance Audio software development kit (SDK) was used to spatialize the audio streams of the conversations. The trajectories for these conversations were designed based on the following criteria:
The trajectories were confined to the frontal half of the horizontal plane of the subject in a semi-circular fashion. In other words, the conversations were made to move on a semi-circular path at a fixed distance from the subject spanning −90 degrees (right) to +90 degrees (left).
The trajectories were initially generated with a resolution of 1 degree and a sampling rate of 0.5 Hz using a first order Markov chain.
This Markov chain had 181 states (−90 degrees to +90 degrees with a resolution of 1 degree). All states were equally probable of being the initial state.
The subsequent samples of a trajectory were generated with a probability transition matrix shown in FIG. 10.
The resulting trajectories were smoothed with a moving average of five samples and then stretched to span the whole frontal half plane.
The trajectories were further upsampled using linear interpolation to 10 Hz.
A pair of trajectories corresponding to a pair of conversations in a trial also followed the following criteria:
   The spatial separation between the conversations when the second conversation starts was set to be at least 90 degrees.
   The spatial separation between the conversations during the talker switch in the to-be-attended conversation was ensured to be at least 45 degrees.
   The correlation of the two trajectories was ensured to be less than 0.5.
A total of 1000 trajectory sets (each with 28 pairs, one for each of the 28 trials) were generated based on the above criteria.
To have the trajectories span a uniform joint distribution, the set with the highest joint entropy (computed with a bin size of 20 degrees) was chosen as final.

In addition to the two conversation streams, a monaural background noise was duplicated for both left and right channels introduced in the auditory scene. For every trial, the background noise was either pedestrian noise or speech babble noise. When mixing the three streams the power of the two conversation streams was always kept the same. The power of the background noise stream was suppressed relative to the power of a conversation stream by either 9 dB or 12 dB. Trial parameters such as background noise type, its power level and voice actor assignments were all counterbalanced across the trials. Stimuli was delivered to the participants with a sampling rate of 683 44.1 kHz through stereo earphones (Panasonic RP-HJE120). After the 28 multi-talker trials, Subjects 1 and 3 also listened to 20 single-talker trials, the neural data of which has not been analyzed in this work.

Assignment of male and female talkers to various segments of the conversations was counterbalanced across trials to ensure equal durations of concurrent conversations with same and different genders. The subjects were instructed to follow (attend to) the conversation that started first and press a push button upon hearing a repeated word in the following conversation. The uncued (to-be-unattended) conversation started 3 seconds after the onset of the cued (to-be-attended) conversation (which in the example of FIG. 4 was the conversation associated with the audio graph 410). The trials were spatialized using head-related transfer functions (HRTFs) and delivered to the subjects via earphones.

The push button responses of subjects to repeated words in the conversation being followed helped in determining to which conversation a subject was attending. A repeated word in a conversation was considered as correctly detected only if a button press was captured within two seconds of its onset. Experimental results showed that all subjects tracked more than 65% of the repeated words in the cued (to-be-attended) conversation (successful identification of repeated words in an attended-to conversation was classified as a “hit”). However, subjects also tracked a non-zero fraction of repeated words in the uncued (to-be-unattended) conversation (such occurrences were classified as “false alarms”) indicating that there might have been occasions when the subjects were attending to the uncued (to-be-unattended) conversation. The hit rate and false alarm rate for each subject were combined to generate a sensitivity index (d′) inspired by signal detection theory (SDT). Sensitivity index for each subject was calculated as: d′=z (False Alarm Rate)−z (Hit Rate), where z(x) is the z-score corresponding to the right-tail p-value of x. Subjects were ranked based on their sensitivity indices (S1: 2.8, S2: 2.3, S3: 1.9).

In order to decode the attended talker, neural signals were compared with speech spectrograms and trajectories of talkers using canonical correlation analysis (CCA). For certain trials where it was evident that the subject was following the uncued conversation (greater than or equal to two repeated words detected in the uncued stream), the “attend” and “unattend” labels were swapped for the conversations in that portion. Subject-wise CCA models were trained, and their performance was evaluated using leave-one-trial-out cross validation, i.e., training on N−1 trials and testing on the windows from the Nth trial. During training, the CCA models simultaneously learn forward filters on attended talker's clean speech spectrogram and trajectory and backward filters on the neural data such that upon projection with these filters, the neural data and the attended talker stimuli would be maximally correlated. During testing, these learnt filters were applied to the neural data as well as to every talker's speech spectrogram and trajectory. The talker which yielded the highest correlation score (based on voting of the top three canonical correlations) was determined as the attended talker. A receptive field of 500 ms was chosen for neural data and 200 ms for stimuli spectrograms and trajectories. The starting sample of the receptive field windows were aligned in time for both neural data and stimuli.

Auditory attention decoding accuracies were evaluated for all subjects for a range of window sizes from 0.5 s to 32 s for the following two stimuli versions:
1) Clean Stimuli: Using the clean (before mixing) ground truth speech spectrograms and trajectories of individual talkers in the acoustic scene.
2) Automatically Separated Stimuli: Using the speech spectrograms and estimated trajectories of talkers yielded by the binaural speech separation model.

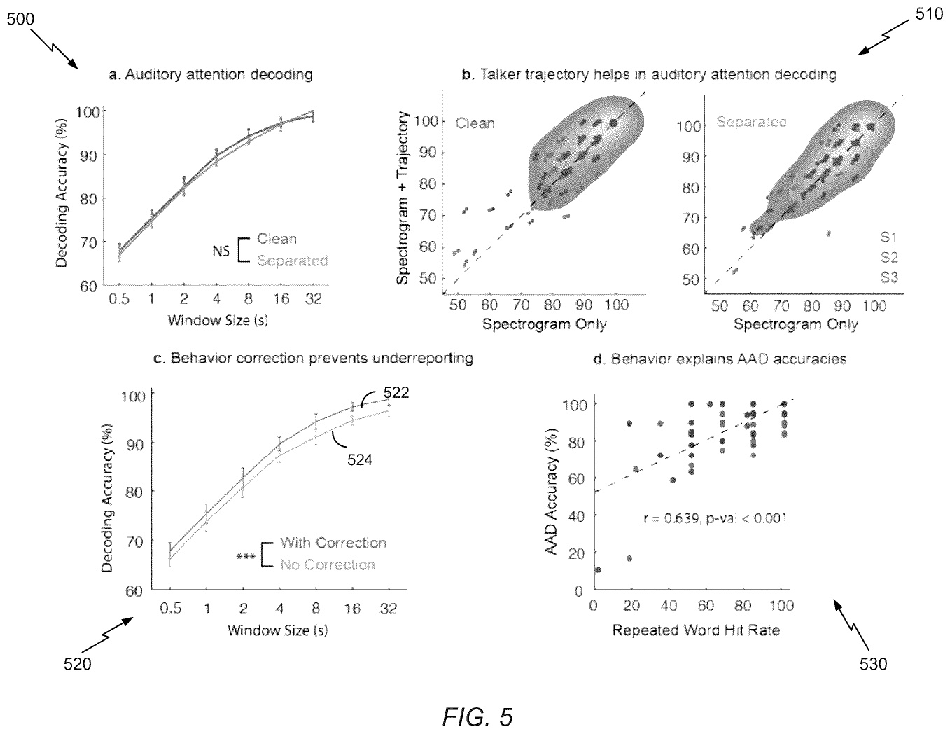

With reference to FIG. 5, graphs illustrating performance behavior and results for the proposed framework described herein are provided. Graph 500 shows the attended talker decoding accuracies averaged across subjects as a function of window size for both clean and separated versions after correcting for behavior. For both versions, the attended talker decoding accuracies increase as a function of window size. This is expected since with larger window sizes, more information is available to determine the attended talker. Stimuli version had a very small effect on the AAD accuracies across subjects and window sizes (Wilcoxon signed-rank test, p-val=0.13). This indicates that the AAD performance with automatically separated stimuli is as good as the performance with original clean stimuli, confirming the efficacy of the proposed speech separation approach.

The improvement in AAD performance was investigated when talker trajectories were included in addition to talker spectrograms. For this comparison, CCA models were trained and tested (post behavior correction) with only talker spectrograms without trajectories. Graph 510 includes scatter plots comparing trial-wise AAD accuracies for a window size of 4 s when using only spectrogram versus spectrogram+trajectory. Each point represents a trial. As shown in the graph 510, the trial-wise AAD performance improved when talker trajectories are also incorporated in addition to talker spectrograms for both clean (paired t-test, p-val=0.002) and automatically separated (paired t-test, p-val=0.010) versions of the stimuli.

Next, an investigation was conducted as to whether lack of having a behavioral measure, and not correcting for the same, can lead to underreporting of AAD performance. To study this, a set of CCA models was trained assuming that the subjects always paid attention to the cued (to-be-attended) conversation. A separate set of models were trained without correcting for behavior. The decoding accuracies are plotted for the clean version of speech for both with behavior correction (at graph 522) and without behavior correction (at graph 524). Not correcting for behavior can be seen (e.g., by comparing curve 522 to curve 524) to significantly hurt AAD performance (Wilcoxon signed-rank test, p-val<0.001). This is also true when evaluating with the automatically separated version of the stimuli (Wilcoxon signed-rank test, p-val<0.001).

Next, for the models trained without correcting for behavior, an investigation was conducted to examine whether the behavioral performance on the repeated word detection task could explain the AAD performance on a trial-by-trial basis. The proportion of repeated words detected in the cued conversation (hit rate) was computed for each trial and for each subject. The corresponding trial-wise AAD accuracies for a window size of 4 s was also computed. As shown in graph 530 of FIG. 5, the hit rate on the repeated word detection task was found to be significantly correlated with the trial-wise AAD accuracies (Pearson's r=0.639, p-val<0.001).

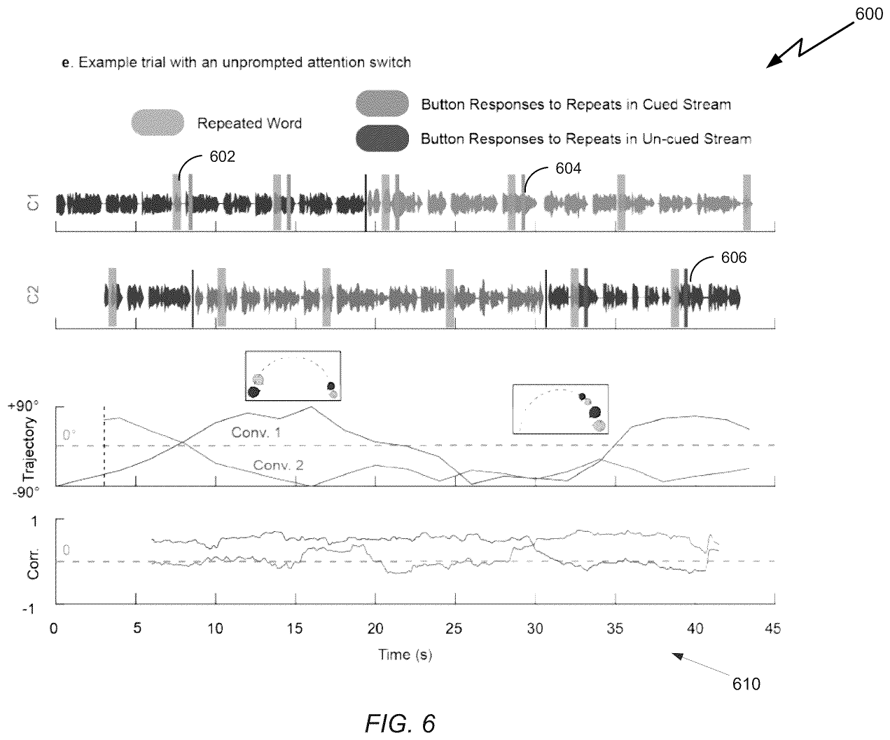

FIG. 6 includes graphs 600 illustrating experimental results obtained from a trial conducted for one of the subjects who, based on behavioral responses, was initially attending to the cued (to-be-attended) conversation and then later attends to the uncued (to-be-unattended) conversation after the conversations cross in space. Repeated words in the conversation streams are indicated by thick rectangular pulses (such as rectangular 602), while button press responses to the repeated words are shown in light-shaded thin rectangular pulses (such as pulse 604) for the cued conversation and dark-shaded thin rectangular pulses (such as rectangular pulse 606) for the uncued conversation. The last plot (graph 610) shows the first canonical correlation for both the conversation streams obtained by continuously sliding a 4 s window. Behavior is well correlated with the canonical correlations. The canonical correlations mapping the neural data with both the cued and uncued stimuli also capture this shift of attention from one conversation to the other. Thus, the repeated word detection task helps explain AAD performance on a trial-by-trial basis.

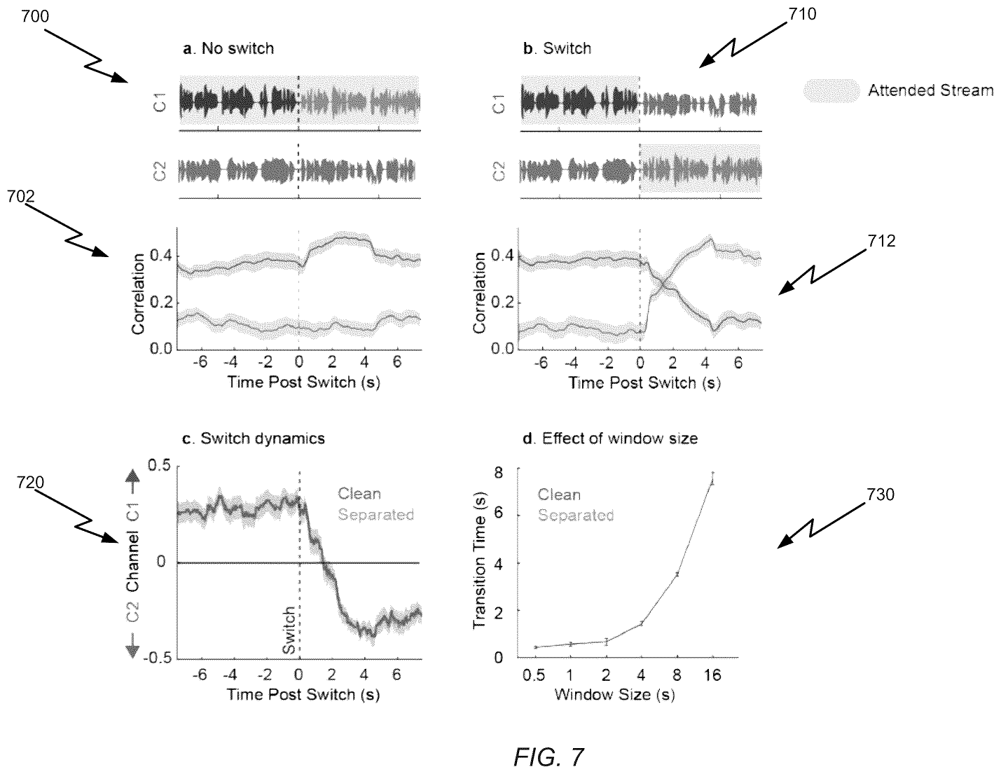

Next, in another experiment, the performance of the proposed framework was examined during turn-taking (i.e., when a non-talking speaker in a group of speakers that are spatially moving together, or are otherwise close together, starts talking). Turn-takings during conversations create talker switches in the attended conversation. For good user experience, it is important that the system tracks the talker switch and seamlessly enhances the new attended talker. The experiment paradigm, inspired by real-world settings, had asynchronous talker switches in both to-be-attended and to-be-unattended conversations. For a particular conversation (between two talkers), the new talker starts talking at the same (or substantially the same) location as where the first talker in the conversation was when the first talker stopped talking. As illustrated in graphs 700 and 702 of FIG. 7, the speaker separation model is able to put talkers of a conversation on the same output channel using location and talker continuity. As a result, the system is able to seamlessly track turn-takings in conversations. The correlation graph 702 shows the average of the top three canonical correlations for separated version of the stimuli.

In some cases, the wearer of the hearing device might switch attention from a conversation at a particular location to another conversation at a different location. To study how the proposed framework responds in such cases, the outputs of the binaural speech separation system were arbitrarily swapped at the point of talker switch in the cued conversation, as shown in graphs 710 and 712 of FIG. 7. Since the results of the top three canonical correlations are combined based on voting to determine the attended talker or channel, a metric channel preference index (CPI) was defined, namely:

$$CPI = ( \# of votes favoring Channel 1 ) / 3 - 0.5$$

Thus, a positive CPI would indicate a preference to Channel 1 whereas a negative CPI would indicate a preference to Channel 2 (for the specific experiment involving the three subjects). In graph 720 the CPI averaged across trials for one of the subjects (S3) is shown when attention switch is simulated. The transition time is defined as the time point where the average CPI crosses 0. Graph 730 shows the transition times (averaged across subjects) as a function of window size for both clean and separated versions. No significant difference was found in the transition times across subjects and window sizes between the clean and separated versions (Wilcoxon signed-rank test, p-val=0.70).

To perform a subjective evaluation of the performance of the proposed framework an online Amazon MTurk experiment was conducted with 24 native speakers of American English. The participants listened to simulated output of the proposed system using the neural signatures obtained by concatenating the channels from all the three subjects, for a total of 15 trials, five for each of the following conditions, in a blind fashion:
1) System Off: The raw mixture stimuli that was played to the subjects from whom neural data (via iEEG) was recorded.
2) System On (Separated): Mixture in which the attended talker, as determined by the neural signatures, was enhanced using the output of the binaural speaker-separation model.
3) System On (Clean): Mixture in which the attended talker was enhanced using clean ground truth speech.

Enhanced mixtures were generated by suppressing the un-attended talker and the background noise in the mixture by the same scale factor such that the resulting power difference between the attended and the unattended talker was 9 dB. Like the iEEG participants, the MTurk participants were also instructed to follow the cued conversation and press space bar on their keyboards upon hearing the repeated words in the conversation being followed. After each trial, the participants were asked to rate the difficulty of following the cued conversation on a scale from 1 (very difficult) to 5 (very easy) and the quality of voices in the conversation on a scale from 1 (bad) to 5 (excellent). In order to also test the intelligibility of the conversations, the participants were also asked to respond to a multiple-choice question based on the content of the cued conversation after each trial. A short localization task was also included at the end of each trial to determine if the attended talker can be localized post enhancement.

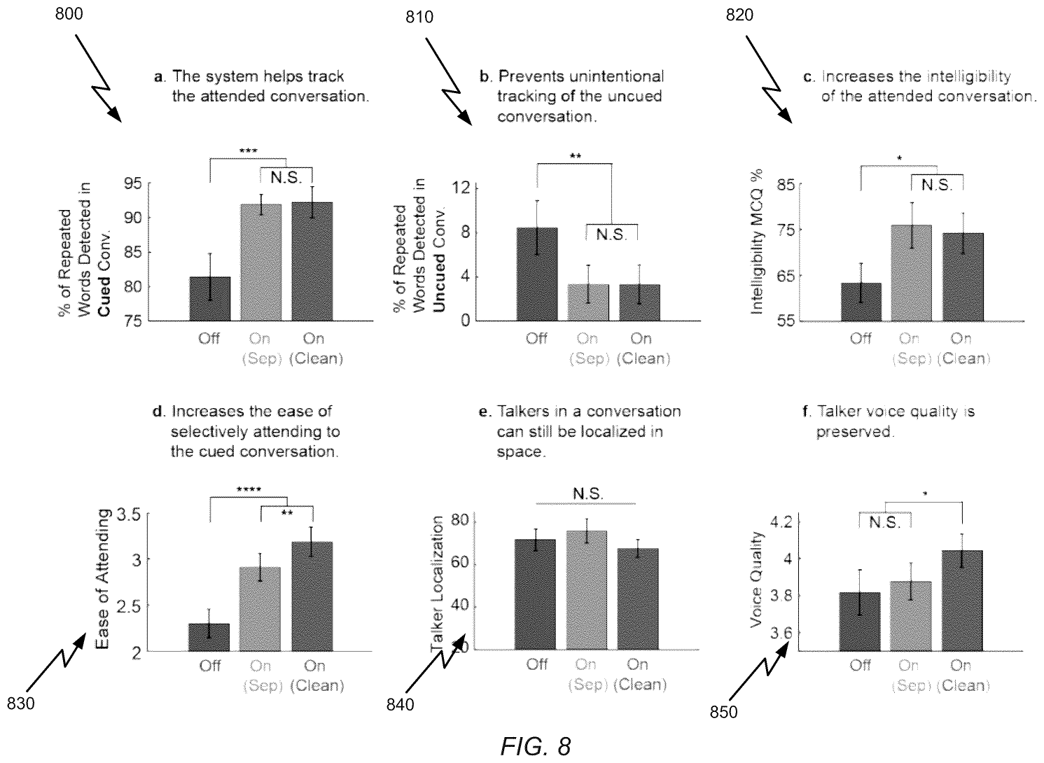

FIG. 8 includes graphs summarizing subjective performance evaluation results for the proposed framework. As shown graph 800, under both the “system on” conditions, the repeated word detection accuracy in the cued conversation is enhanced when compared to the “system off” condition (paired t-test, p-val<0.001), whereas for the uncued conversation (as illustrated in graph 810), the detection accuracy is reduced (paired t-test, p-val<0.01). This means that the system helps track the cued conversation and prevents unintentional tracking of the uncued conversation. The intelligibility of the cued conversation was found to be significantly enhanced under the “system on” conditions, as shown in graph 820 (paired t-test, p-val<0.05). No significant differences are observed between the clean and separated versions of the “system on” condition. Ease of attending to the cued conversation increases from “system off” condition to “system on with separated speech” condition (paired t-test, p-val<0.0001) to “system on with clean speech” condition (paired t-test, p-val<0.01), as shown in graph 830. Surprisingly, no differences in voice quality of the talkers in the cued conversation were observed between the “system off” and the “system on with separated speech” condition (see graph 840). However, participants rated the voice quality in the “system off with clean speech” condition higher than the other two (paired t-test, p-val<0.05). These results indicate that a scope for improvement exists for the binaural speech separation model and its upper bounds (when there is ideal separation) are captured by the “system on with clean speech” condition. The ability to localize talkers in space, as shown in graph 850, was comparable across all the three conditions highlighting retention of the attended talker spatial cues when the system is turned on. In summary, the system helps follow the conversation of interest, increases its intelligibility and the ease of attending to it while also preserving spatial cues.

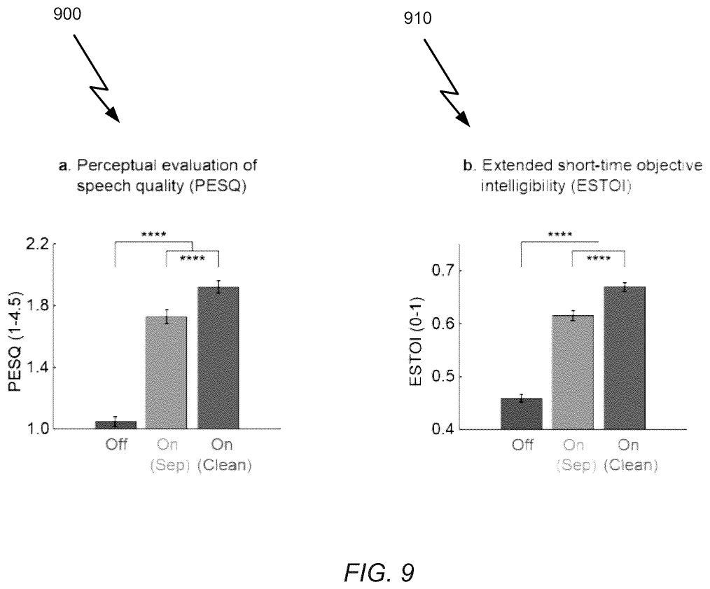

In addition to subjective performance evaluation of the proposed framework, an objective performance evaluation of the proposed framework was also conducted, where the same system simulated outputs used in the subjective evaluation discussed above were compared with their corresponding clean to-be-attended conversation waveforms (as reference) to calculate narrowband MOS mapped Perceptual Evaluation of Speech Quality (PESQ) and Extended Short-Time Objective Intelligibility (ESTOI) scores. As expected, FIG. 9, providing graphs 900 and 910 summarizing the results of the objective performance evaluation for the proposed framework, shows a significant improvement in these objective scores as the system progresses from “system off” condition to “system on with separated speech” condition, to “system on with clean speech” condition (paired t-tests, p-val<0.0001).

Thus, the above-discussed framework introduced a realistic AAD experiment paradigm with concurrent conversations where each conversation included turn-takings. In addition, the conversations were moving in space in the presence of background noise. The proposed framework included a novel binaural speaker separation system that was able to causally separate the mixture of moving conversations into their individual streams while also preserving their spatial cues and suppressing background. It was found that incorporating talker trajectories in addition to their spectrograms (or other representation of the talkers' audio signals) yields improved AAD performance. The deliberate insertion of repeated words across the conversations helped determine the true attended conversation with a high temporal resolution which also explained AAD performance on a trial-by-trial basis. Evaluations of the proposed system revealed that the system makes following the attended conversation easier, increases its intelligibility and preserves the perceived location of each talker in space.

An important consideration for implementing the proposed framework was to consider realistic settings for AAD, which is necessary for practical implementation of brain-controlled hearing devices. First, most previous research has assumed stationary talkers, limiting the generalizability of previously proposed systems to real-world scenarios with freely moving speakers. Here, the framework introduced a novel speech separation model that leverages spatial and spectro-temporal information from binaural microphone receivers to separate mixtures of moving talkers. To create an immersive and augmented listening experience, the model preserves the spatial cues of moving talkers in stereo outputs, enabling listeners to accurately perceive the talker locations. A natural question following this is whether this preserved location information can be used to improve AAD as signatures of auditory spatial attention have been shown in the auditory cortex. It was found that incorporating trajectories in addition to spectral speech information helps boost AAD accuracies (e.g., by favoring new sound sources that are in the vicinity of, and/or following a similar path, as an attended to sound source that has just terminated).

Second, almost all prior studies have only presented two talkers and instructed subjects to attend to one, which is unrealistic compared to real-world scenarios involving multiple talkers. For example, people usually hear simultaneous conversations at different tables in a restaurant. The investigation described herein extends previous work by replacing concurrent talkers with concurrent conversations involving natural turn-taking. It was demonstrated that the proposed brain-controlled hearing device system can seamlessly track turn-takings.

Third, studies have assumed that subjects would always attend to the cued stream. However, attention to the uncued stream can result in mislabeled data and hinder AAD model training and evaluation. It is therefore important to have a behavioral measure incorporated into the experiment paradigm that could potentially indicate the attended talker/conversation with a high degree of temporal resolution and help correct labels for such regions. The deliberate insertion of repeated words across the conversations is also a novel contribution through which the true attended conversation can be determined with a high temporal resolution (which can help define proper ground truths, and thus facilitate training of machine-learning mechanisms to perform AAD. In future AAD studies with moving talkers, a higher degree of temporal resolution can be achieved by asking the subjects to also indicate the motion path of the conversation being followed (e.g., through a joystick). A challenge with such an experiment design is that it would also generate additional motor-related neural components that need to be regressed out.

Several changes can be made to the current experiment design to make it even closer to real world scenarios. The motion of the talkers in the conversations in the current design can be made more complex by also allowing motion in the radial direction in addition to the current azimuthal motion. Motion pauses can also be introduced for the talkers in the conversations. This would mean conversations could get louder (or feebler) as the talkers approach (or leave) the listener. This would translate to the presence of conversations of time-varying power in the acoustic scene which could potentially be a challenge for a speaker separation model. This can probably be addressed by retraining/fine-tuning the speaker separation model on a synthetic dataset with similar characteristics.

Some further improvements and features that can be included with the proposed framework include the following. Prior invasive and non-invasive AAD studies have shown signatures of auditory attention (via tracking of the envelope of the attended speech) in the lower frequencies (1-7 Hz). A recent study also showed that low frequency neural activity tracks the motion of the attended talker, especially delta (<2 Hz) phase and alpha (8-12 Hz) power. Incorporation of low frequency neural activity in addition to high gamma activity (70-150 Hz). can potentially help increase AAD accuracies. Most AAD studies have used an open loop setup where the data was recorded and analyzed offline, and the audio that was delivered to the listener was not modulated by attention. A realistic brain-controlled hearing device requires real-time closed-loop implementation. This would require all the blocks of the proposed framework, including speech separation and AAD to work together synchronously and be implemented in a causal real-time manner. Moreover, how to best manipulate/re-mix the acoustic scene once the attended talker has been decoded also requires further investigation. A recent closed-loop AAD study using scalp EEG found that it is important for the system to quickly track switches in attention in order to achieve desirable user experience. Fast detection of attention switches requires shorter window durations, made possible with invasive EEG techniques. It would therefore be useful that a closed loop version of the proposed framework, in which the attended talker is enhanced in an online real-time fashion and fed back to the subject, be tested and characterized.

To build brain-controlled hearing devices deployable in real-world settings, experimental acoustic scenes in which such systems get trained and tested need to get more complex. In the present description an experiment paradigm was designed with acoustic scenes consisting of moving conversations, turn-takings, and background noise. A system framework was also proposed and evaluated to handle such settings. The system was shown to preserve binaural cues of talkers in the acoustic scene, thereby making the listening experience more natural and allowing the wearers to localize talkers. The system was also shown to increase intelligibility of the conversation of interest and reduce listening effort. Such a system can dramatically improve the quality of life for the hearing-impaired and augment hearing capabilities for the general public.

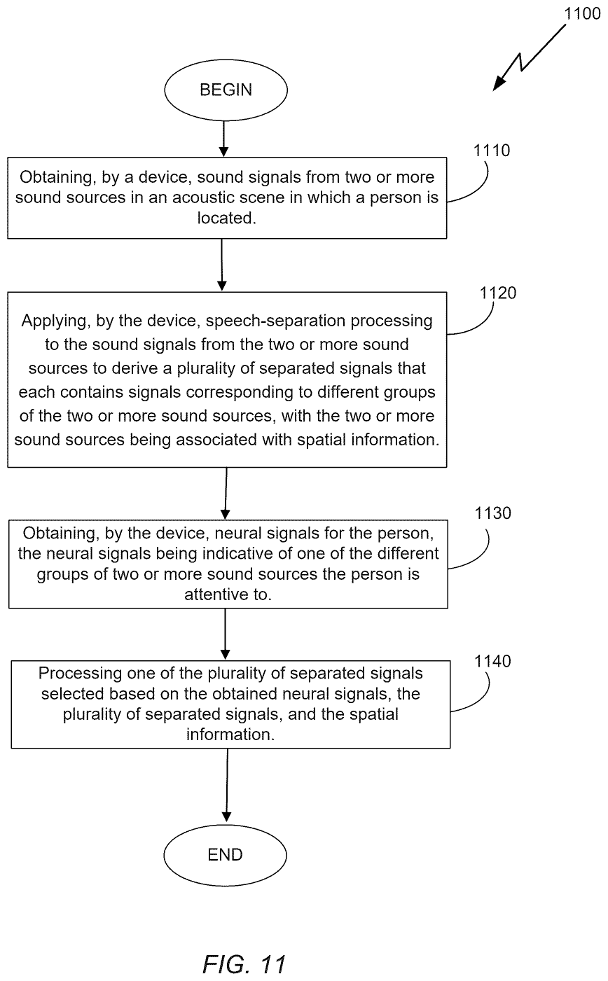

With reference to FIG. 11, a flowchart of an example procedure 1100 for sound processing is provided. The procedure 1100 includes obtaining 1110, by a device (e.g., a binaural hearing device), sound signals from two or more sound sources in an acoustic scene in which a person is located. Any such sound sources may include multiple sound producing signals, e.g., human talkers, and each such sound source may be stationary or moving. The procedure 1100 further includes applying 1120, by the device, speech-separation processing to the sound signals from the two or more sound sources to derive a plurality of separated signals that each contains signals corresponding to different groups of the two or more sound sources, with the two or more sound sources being associated with spatial information.

In some embodiments, applying the speech separation processing may include separating the sound signals according to a time-domain audio separation network (TasNet) approach implemented with an encoder-decoder architecture. As previously noted, other speech separation approaches may be used instead of, or in addition to, the TasNet approach. Separating the sound signals may include processing two or more channels (e.g., left ear and right ear) of mixed sound signals produced by the two or more moving sound sources by respective linear encoder transforms to produce resultant 2-D representations of the mixed sound signals, and filtering the resultant 2-D representations of the mixed sound signals and a representation of the spatial information using a series of temporal convolutional network (TCN) blocks to estimate multiplicative masks. The separating the sound sources operations may further include applying the estimated multiplicative masks to the resultant 2-D representations of the mixed sound signals to derive masked representations of separated sound signals for the two or more channels, and filtering the masked representations of the separated sound signals using a linear decoder transform to derive separated waveform representations for different groups of talkers from the two or more sound sources. The series of temporal convolutional network (TCN) blocks may include multiple repeated stacks that each includes one or more 1-D convolutional blocks.

In various examples, the procedure 1100 may further include performing post-separation enhancement filtering to suppress noisy features, including processing the mixed sound signals and the separated sound signals with respective linear encoder transforms to produce resultant 2-D post-enhancement representations, filtering the resultant 2-D post enhancement representations using a series of post-enhancement temporal convolutional network (TCN) blocks to estimate post-enhancement multiplicative masks, and applying the estimated post-enhancement multiplicative masks to the resultant 2-D representations of the mixed sound signals to derive masked representations for the two or more channels. The post-separation operations may further include summing the masked representations for the two or more channels to obtain a summed masked representation, and filtering the summed masked representation using a linear decoder transform. Other types of enhancement operations, such as beamforming, may also be performed.

In some embodiments, the procedure may further include determining the spatial information associated with the two or more sound sources. In such embodiments, determining the spatial information associated with the two or more sound sources may include deriving sound-based estimated trajectories of the two or more sound sources in the acoustic scene. Determining the spatial information may include deriving one or more of, for example, inter-channel phase differences (IPDs) between a first sound signal captured at a first microphone for one ear of the person and a second sound signal captured at a second microphone for another ear of the person, and/or an inter-channel level differences (ILD's) between the first sound signal and the second sound signal.

Turning back to FIG. 11, the procedure 1100 further includes obtaining 1130, by the device, neural signals for the person, the neural signals being indicative of one of the two or more sound sources the person is attentive to, and processing 1140 one or more of the plurality of separated signals selected based on the obtained neural signals, the plurality of separated signals, and the spatial information.

In examples, obtaining the neural signals for the person may include obtaining the neural signals according to one or more of, for example, electrocorticography (ECoG) recordings, invasive intracranial electroencephalography (iEEG) recordings, non-invasive electroencephalography (EEG) recordings, functional near-infrared spectroscopy (fNIRS) recordings, minimally-invasive neural recordings, ear electroencephalography (EEG) recordings, recordings captured with stentrodes, and/or recordings captured with subdural or brain-implanted electrodes.

In some embodiments, processing one or more of the plurality of separated signals may include performing canonical correlation analysis based on the neural signal representations, estimated trajectory representations of the two or more sound sources, and the plurality of separated signals, to identify an attended speaker. Performing the canonical correlation analysis may include applying a machine learning canonical correlation analysis model to machine learning model input data derived from the neural signal representations, the estimated trajectory representations, and the plurality of separated signals. Processing one or more of the plurality of separated signals comprises performing one or more of, for example, amplifying the at least one of the plurality of separated signals, and/or attenuating at least another of the plurality of separated signals. In various examples, processing one or more of the plurality of separated signals may include performing auditory attention decoding based on the neural signal representations, estimated trajectory representations of the two or more sound sources, and the plurality of separated signals, to identify an attended speaker. As noted, AAD results improve when using all three of neural signals, speech signals, and trajectory (or some other spatial information representation), than when just using the neural signals and speech signals.

As noted above, the description provided herein focused on an implementation that used the TasNet approach to perform an audio separation processes (via the separation module 160 and the Post-Enhancement module 180 of FIG. 1). However, other speech separation techniques and approaches may be used with the spatial information-aided auditory attention decoding (AAD) implementations described herein. An example speech separation and selection approach that has produced excellent experimental results (including in terms of listener-perceived subjective results) is an implementation in which the high and low frequency components of measured neural signals are used to generate an estimated speech envelope that correlates to one of multiple separated speech envelopes, produced from the auditory inputs, that the listener is attending to. As discussed in greater detail below, the high and low frequency bands, flanking a middle band that may be discarded (e.g., through a band-rejecting filtering process, or alternatively by combining the outputs of a high pass filtering process and a low pass filtering process applied to the measured neural signals) are used to derive the estimated speech envelope that can then be compared to the resultant separated speech envelopes derived using the applied speech separation approach (be it a binaural approach, a single microphone approach, or a multiple microphone approach, with such approaches implementing various types of speech separation techniques, including the techniques described with respect to FIGS. 1-11). To measure neural signals with sufficient precision and resolution that the neural signals can be processed to generate separate bands, invasive brain electrode (e.g., subdural electrodes, or electrodes embedded into the brain tissue) may be used. However, non-invasive electrodes (e.g., placed on the scalp), electrodes placed around or in the listener's ears, etc., and minimally invasive electrodes such as stentrodes (electrodes placed using stents), preferably with sufficient sensitivity, may also be used.

The inclusion of spatial information (when available, such as, for example, when relative phase information can be derived from audio signals received by two or more microphones) can be performed similarly to the approaches discussed in relation to FIGS. 1-11. Thus, in such embodiments, separated speech data (e.g., represented as speech envelopes) and associated spatial information may be fed into a canonical correlation analysis (CCA) unit that also receives as input neural signals (or alternatively, a resultant representation thereof, such as a speech envelope derived from a low and high frequency bands of the neural signals). The CCA unit (which may be similar to the CCA unit 150 of FIG. 1, but may be configured to receive and operate on data according to the proposed speech envelope comparison approach) performs a multivariate analysis to derives the relationship between the multidimensional variables. Here too, other processing approaches to combine spatial information to aid AAD operations may be used.

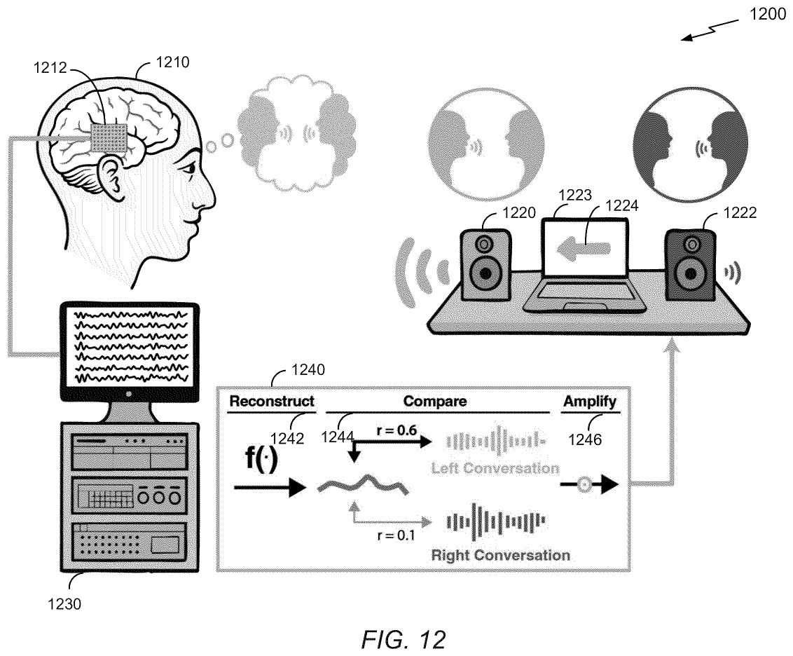

FIG. 12 is a diagram of an experimental paradigm that was implemented to test the effectiveness of a real-time closed-loop auditory attention decoding (AAD) system 1200 to determine the attended to sound source based on comparison of an estimated and separated audio speech envelopes. For simplicity, the system 1200 depicted in FIG. 12 does not illustrate the incorporation of spatial information into the AAD process, but such spatial information can be readily incorporated (e.g., in a manner similar to the incorporation of spatial information in the embodiments of FIGS. 1-11) in order to improve the accuracy of the AAD process. As noted, the system 1200 of FIG. 12 uses a closed-loop implementation in which the amplitudes of separated signals are continually adjusted (e.g., enhancing one of the signals and/or attenuating another of the signals) based on changing neural signals (which can represent the listener's attention and his/her subjective experience). In some embodiments (including in the experimentation performed to test and evaluate the system of 1200 FIG. 12), invasive electrocorticography (ECoG), which provides measurements with high SNR and high spatial resolution, can be used to perform the attention decoding to accurately and dynamically track a user's desired direction of attention. The ECoG approach (and/or other approaches using other types of brain activity measuring techniques) allows for testing how to best modulate the volume of the sound sources in a multi-sound source environment in order to optimize the subjective experience of a user. Importantly, by doing so in a closed loop, the framework can track a switch in attention when the user decides to attend to another speaker. The implementations of FIG. 12 can include any other type of neural sensors, including any of the invasive and non-invasive sensing electrodes described herein. Further details regarding closed-loop AAD implementations can be found in U.S. Pat. No. 12,165,670, entitled “Systems and methods for speech separation and neural decoding of attentional selection in multi-speaker environments,” the content of which is incorporated herein by reference in its entirety.

As shown, a listener 1210 is situated in an environment that includes multiple separate sound sources (e.g., multiple speech signals generated during multiple conversations). In the experiments conducted using the set up of FIG. 12, recordings of the two conversations were played on two separate speakers 1220 and 1222 (left and right speakers) that represent and simulate spatially separated sound sources. The listener 1210 would typically try to focus on one specific audio signal (e.g., a conversation) from the multiple sound signals arriving from different sound sources.

The listener's observations of the on-going auditory scene results in neural activity that captures, in part, the particular conversation, or sound source, the speaker is attending to (i.e., focusing on). The neural activity is recorded by one or more neural sensors 1212 (e.g., invasive and/or non-invasive brain electrodes) that forward the recorded neural signals to a processing system 1230 (e.g., comprising one or more computing devices) to, among other things, process the neural signals. As noted, in some embodiments, the various recorded neural signals may be filtered to extract the high band of neural signals (e.g., 70-150 Hz) and the low band of the neural signals (e.g., 0.5-30 Hz). The middle band of the neural signals (e.g., 30-70 Hz) may be discarded (although in some embodiments, the middle band may be combined in some way with the high and low bands portions, e.g., combined in full or combined partially through appropriate weighing).

The extracted portions of the neural signals are provided to a processing pipeline 1240 (generally implemented on the processing system 1230) that includes a reconstruction stage 1242 (represented as an operator f(·)) to generate, from the extracted neural signal portions, an estimated speech envelope representing the envelope of the speech the listener is attending to). The reconstruction can be performed, for example, through algorithmic transformation of neural signal portions into an estimated speech envelope, or by using a machine learning model that generates, in response to neural signals inputs (e.g., high and low frequency portions of multiple neural signals), an estimated speech envelope. The processing system 1230 (or some other processing device or system) is further configured to extract the speech envelopes from the audio recordings being played on the left and right speakers 1220 and 1222 (in real-life situations, the processing system 1230 may also be configured to perform speech separation, using one or more speech separation techniques, such as the techniques described herein, on combined audio signals that represent sound from multiple sound sources). The estimated speech envelope and the actual speech envelopes are provided to a compare stage 1244 that compares the estimated speech enveloped to the actual speech envelopes and determines which of the actual speech envelopes provided most closely matches the estimated (reconstructed) speech envelope. The selected speech envelopes that most closely matches the estimated speech envelope (i.e., most similar to, or closest to the estimated envelope according to some correlation or distance measure criterion) is deemed to correspond to the sound source (or sound recording in the case of the example of FIG. 12) that the listener is attending to. Accordingly, adjustable amplification coefficients are adjusted (e.g., incrementally, every one or more iterations) to amplify the selected speech signal (the attended to sound source) and/or to decrease the amplification factor (i.e., to attenuate) the non-attended to speech signal(s).

The adjusted amplification coefficients are subsequently applied to the respective speech signals in an amplify stage 1246 of the processing pipeline 1240. As noted, in real-life situations, the speech signals being amplified would typically be generated using a speech separation technique applied to one or more combined audio signals that comprise speech signals from multiple sound sources. In the example of FIG. 12, the speech signals to be amplified are recordings of individual sound sources (e.g., individual/isolated conversations) that are being amplified or attenuated based on the outcome at the compare stage 1244 to cause the attended-to recording to be amplified, and the non-attended recording(s) to be attenuated. The adjusted audio signals (amplified and/or attenuated) are directed to their associated speakers (in FIG. 12, one signal is directed to the speaker 1220, and the other signal is directed to the speaker 1222).

Having amplified one signal and attenuated the other signal(s), the listener is now receiving adjusted sound signals. If the listener is in fact attending to the signal that was amplified, the resulting neural signals will indicate continued attention to that signal, which would then cause continued (and possible increased) amplification of that signal. If the wrong signal was amplified, the resulting neural signals will reflect the listener's attempt to focus on (attend) the correct audio signal, which will cause the correct signal to gradually become more amplified, and the other signal(s) to be attenuated. This real-time closed-loop mechanism can thus facilitate enhancement (e.g., amplification) of the signal the listeners is trying to focus on, and to quickly adjust the amplification/attenuation levels applied to the audio signals when the listener's attention switches to another sound source.

Thus, in embodiments of, for example, FIG. 1, the controller configured to process one or more of the plurality of separated signals may further be configured to derive an estimated speech envelope from a low frequency band and a high frequency band of the neural signals, with the low frequency band and the high frequency band being non-contiguous, and select the one of the plurality of separated signals based on a comparison of the estimated speech envelope to respective speech envelopes derived for the plurality of separated signals. In some embodiments, the controller configured to process one or more of the plurality of separated signals can further be configured to perform closed-loop processing on the one of the plurality of separated signals and the neural signals to track attention of the person by continually modulating amplitudes of the plurality of separated signals based on the neural signals obtained at a first time instance to cause a change to the respective amplitudes of the plurality of separated sound signals that cause a resultant change, at a second time instance, to subsequent neural signals for the person to allow real-time attention switching by the person.

The testing and evaluations performed using the implementation of FIG. 12 will next be discussed. The experiments conducted used high-resolution intracranial EEG (iEEG) recordings, to demonstrate that real-time AAD-driven selective hearing can enhance speech perception in noisy environments. To rigorously test the effectiveness of the implementation, three complementary experiments were designed targeting distinct aspects of AAD-driven speech enhancement. A first experiment (referred to herein as “Experiment 1”) tested whether listeners prefer AAD by activating the system mid-trial and measuring its impact on speech perception. A second experiment (“Experiment 2”) examined whether AAD enables flexible attention switching by instructing participants to shift their focus between two competing conversations while the system continuously decoded and amplified the attended speech. A third experiment (“Experiment 3”) assessed whether AAD supports natural, self-initiated attention shifts, allowing participants to freely refocus on different talkers without external cues. Across all experiments, the perceptual and cognitive effects of AAD were quantified using behavioral measures and subjective listener ratings, demonstrating benefits for both normal-hearing and hearing-impaired users. The behavioral validation of AAD's efficacy described herein, the study marks a major step toward brain-controlled auditory prosthetics and establishes a foundation for real-world, brain controlled hearing technologies.

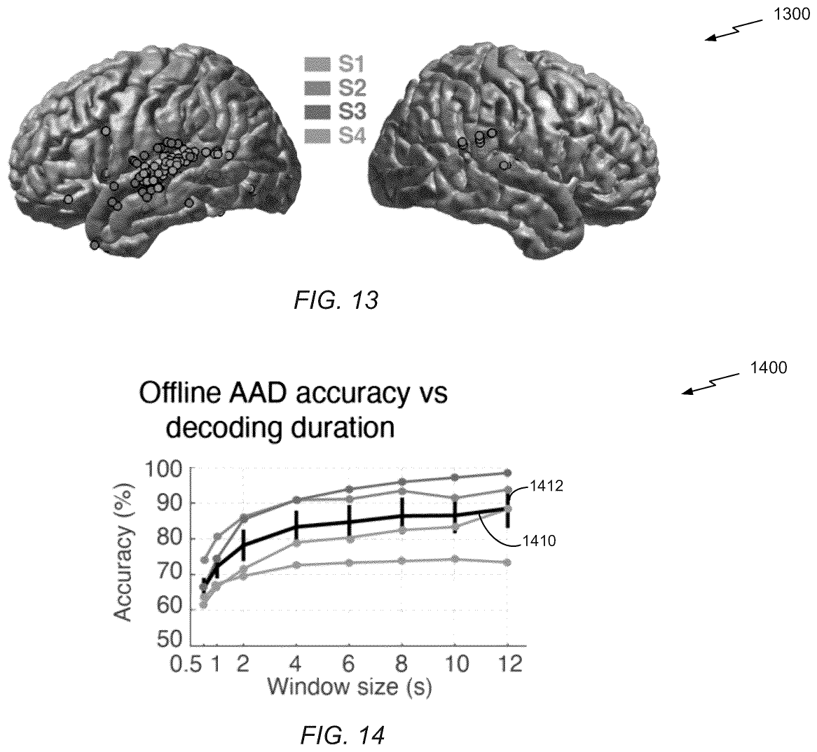

During the testing and evaluations, four participants undergoing epilepsy monitoring with intracranial electroencephalography (iEEG) using implanted electrodes took part in the study. Electrode coverage varied across individuals, with recordings spanning the superior temporal gyrus (STG) and surrounding in the auditory cortex regions known to encode speech-selective neural responses. Electrode coverage varied across individuals. S1 and S3 had stereoelectroencephalography (sEEG) depth electrodes and an electrocorticography (ECoG) grid over the left hemisphere, primarily targeting the temporal lobe. S2 had sEEG depth electrodes in the right hemisphere, while S4 had bilateral sEEG depth coverage. FIG. 13 includes a diagram 1300 showing the different electrode coverages used for the four participants, highlighting coverage of speech-responsive electrodes over auditory cortical regions. All the participants had self-reported normal hearing and were presented with two simultaneous speech streams, each played from separate loudspeakers positioned at ±15° azimuth (the speakers 1220 and 1222 of FIG. 12). Each stream included a naturalistic conversation between two talkers, recorded by voice actors discussing everyday topics such as food, exercise and travel. To monitor attentional engagement, repeated words were inserted into both conversations every few seconds, and participants were instructed to press a button whenever they detected a repeated word in the attended speech. Participants S2-S4 were native speakers of American English, whereas S1 was a non-native speaker. In instructed-attention conditions (Experiments 1 and 2), a visual arrow 1224 (shown in FIG. 12), presented on a display device of a computing device 1223, cued the subject to attend to one of the two conversations.

The experimental set up implementation included an offline phase to train and validate a decoding model for each participant, before testing the model during the online phase for evaluating real-time AAD. In the offline phase, participants were instructed to attend to a cued speaker while ignoring the other as their neural responses were recorded. Each trial was presented at a specific target-to-masker ratio (TMR), with the attended talker at either +9 dB or −6 dB relative to the background talker. Behavioral results confirmed that participants reliably tracked the attended talker. After completion of the offline phase, participant-specific AAD models were trained using linear regression (other techniques are possible) to predict the speech envelope of the attended talker from combined high and low frequency neural activity recorded by the speech-responsive electrodes.

During the online phase, the correlations between the reconstructed and each of the two actual speech envelopes were used to determine attentional focus, which then guided the selective amplification of the attended speech relative to the masker. A 4-second sliding window was selected, with a 0.5-second hop size to achieve a reasonable trade-off between accuracy and real-time adaptability. FIG. 14 includes a graph 1400 illustrating the effect the decoding window size had on AAD accuracy. AAD accuracy (using all speech-responsive electrodes) improves with longer temporal windows. Line 1410 identified in the graph 1400 represents the mean accuracy vs. window size over the four participants (subjects). Error bars (such as the error bar 1412) indicate standard error of the mean.

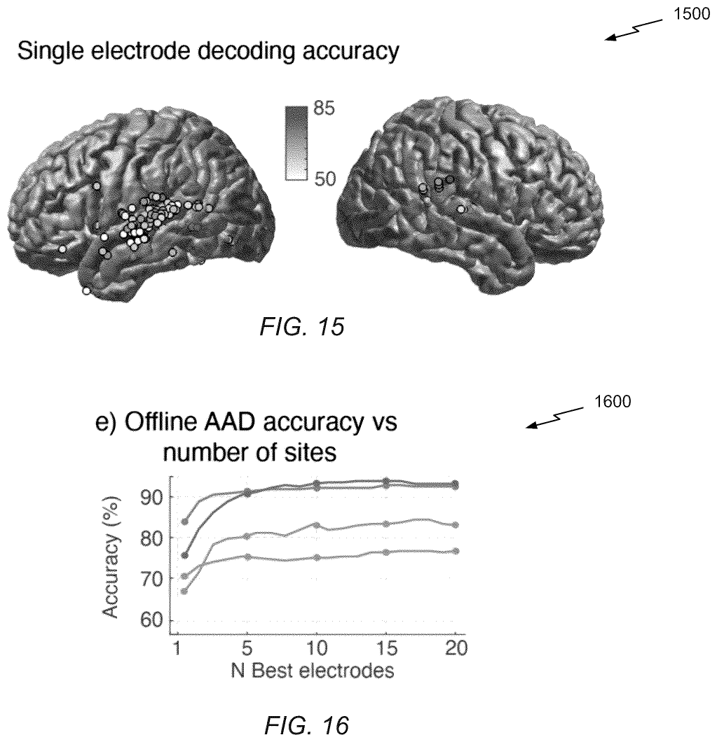

FIG. 15 is a diagram 1500 illustrating the decoding accuracy of individual electrodes, demonstrating variability across recording sites. FIG. 16 includes a graph 1600 illustrating how accuracy improves as additional electrodes are incorporated based on results from forward selection (discussed more particularly below). As shown in FIG. 16, AAD accuracy can be represented as a function of the number of selected electrodes, where each additional electrode is chosen to maximally improve decoding accuracy at each step. To prevent expectation bias during the online phase, subjects were told that the online phase was identical to the offline phase, without knowledge that their neural signals were actively controlling the speech volumes in real time. AAD models that incorporated all speech-responsive electrodes for each subject were used in the online phase.

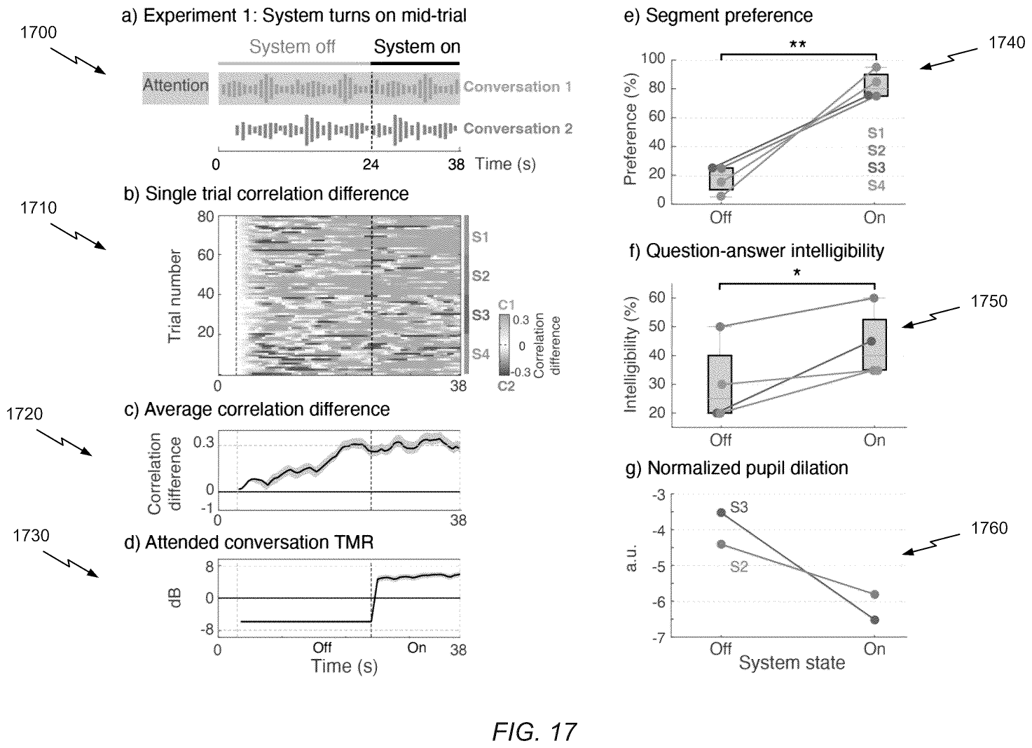

Experiment 1 tested the perceptual benefits of real-time AAD. First, the perceptual benefit of decoding attentional focus and enhancing the attended conversation in real-time was tested. Each trial included two segments, illustrated in a diagram 1700 of FIG. 17, which shows an experimental set up in which participants listened to two competing speech streams while the system remained off in the first half of the trial and was activated in the second half. In the first segment (System Off), the feedback loop was inactive, and target speech was presented at a fixed −6 dB TMR, simulating a difficult natural listening condition. In the second segment (System On), the AAD system was activated, selectively amplifying the neurally decoded attended speech up to +9 dB TMR. At the end of each trial, the participants were asked which segment they preferred listening to and answered two intelligibility questions probing the target conversation content during the two segments. The real-time AAD system accurately tracked attentional focus. As shown in graph 1710 of FIG. 17, illustrating the single-trial correlation differences between the reconstructed and actual speech envelopes, there is clear separation between the attended and unattended streams. This effect was also reflected in the average correlation difference across trials (illustrated in graph 1720, showing average correlation difference, in which the decoding of the attended talker is accurate and stable over time), confirming rapid and stable decoding of auditory attention. This decoding translated into an increase in TMR (illustrated in graph 1730, showing the attended conversation target-to-masker ratio (TMR), where TMR improves significantly after the system is activated, reflecting enhanced speech perception), with the average TMR being +6 dB in the second segment (+12 dB enhancement from the first segment). Shaded error bars in the graphs 1720 and 1730 indicate the standard error of the mean.

The perceptual benefits of AAD-driven selective hearing were evident across multiple measures. As shown in graph 1740 of FIG. 17, illustrating segment preference in which participants reported greater preference for the target talker when AAD was on compared to when it was off, subjects overwhelmingly preferred the System On condition, reporting significantly greater ease in following the attended conversation (two-sided paired t-test, t(3)=6.79, p=0.0065, Cohen's d=3.39). Speech intelligibility also improved, with significantly higher performance in the System On condition compared to System Off (two-sided paired t-test, t(3)=3.22, p=0.0486, Cohen's d=1.61, as illustrated in graph 1750, showing question-answer intelligibility, where participants answered questions about the attended conversation more accurately when AAD was active). Finally, to assess cognitive effort, pupil dilation was analyzed as a proxy for listening effort. Graph 1760 of FIG. 17 illustrates normalized pupil dilation behavior, showing that pupil dilation decreased when AAD was on, suggesting reduced listening effort (S2: two-sided t-test, t(960)=−19.52, p<0.001, Cohen's d=148 1.26; S3: two-sided t-test, t(960)=−33.72, p <0.001, Cohen's d=2.17). Due to clinical constraints associated with the patients' condition, this measure was reliably recorded for only two participants.

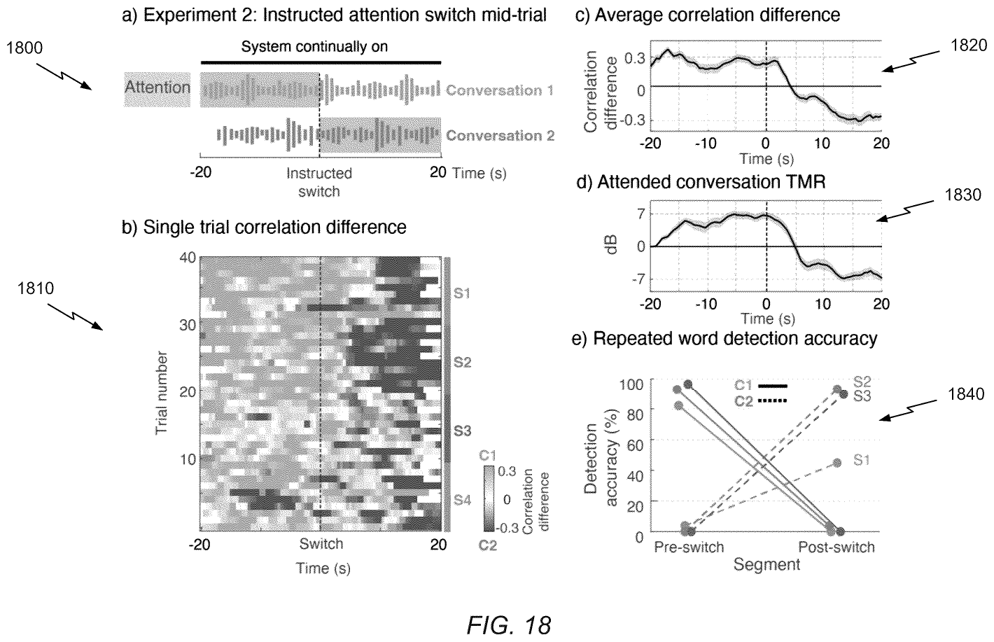

As noted, Experiment 2 conducted instructed-attention-switch trials. In real-world listening, people frequently shift attention between talkers in dynamic environments. Experiment 2 tested whether the AAD system can maintain the ability of the subject to switch attention and accurately and rapidly enhance the newly attended conversation in real time. Each trial included two overlapping speech streams, with subjects initially cued to attend to one (Conversation 1). Midway through the trial, a visual cue instructed them to switch attention to the other (Conversation 2), while the system continuously decoded neural responses and adjusted the volume of the two speech streams accordingly. Diagram 1800 of FIG. 18 illustrates the experimental set up implemented for Experiment 2, in which participants were instructed to switch their attention from one conversation to another at a predetermined time while the system continuously decoded and enhanced the attended speech. Graph 1810 of FIG. 18 illustrates single-trial correlation difference results, in which the difference of correlations between the reconstructed attended speech and each of the two speech streams shows a shift in neural tracking following the instructed switch. The single-trial correlations exhibited a clear transition in attentional tracking, which was further confirmed by the average correlation difference (as shown in the graph 1820 of FIG. 18). Across trials, the correlation difference reverses following the switch cue, indicating successful adaptation of the system to the new attended conversation.

Correspondingly, the system adapted its gain control, with the target-to-masker ratio (TMR) transitioning from positive (favoring Conversation 1) before the switch, to negative (favoring Conversation 2) after the switch cue. Graph 1830 illustrates attended conversation target-to-masker ratio (TMR), where the TMR shifts to favor the newly attended conversation after the attention switch, reflecting dynamic system adaptation. Shaded error bars in graphs 1820 and 1830 indicate the standard error of the mean.

The mean switch time, defined as the time required for the mean TMR to reach 0 dB after the switch cue, was 5.1 seconds across subjects (S1: 7.0 s, S2: 4.5 s, S3: 5.0 s, S4: 4.0 s). This switch time reflects a combination of factors, including participants' reaction times and the system's gain adaptation properties. Speech detection accuracy remained high throughout the transition, confirming that participants successfully followed the instructed switch while AAD dynamically adjusted the TMR in response to decoded attention. Repeat word detection could not be captured for S4 due to hospital equipment malfunction. Graph 1840 illustrates repeated word detection accuracy, where participants accurately tracked repeated words in the newly attended conversation after switching attention.

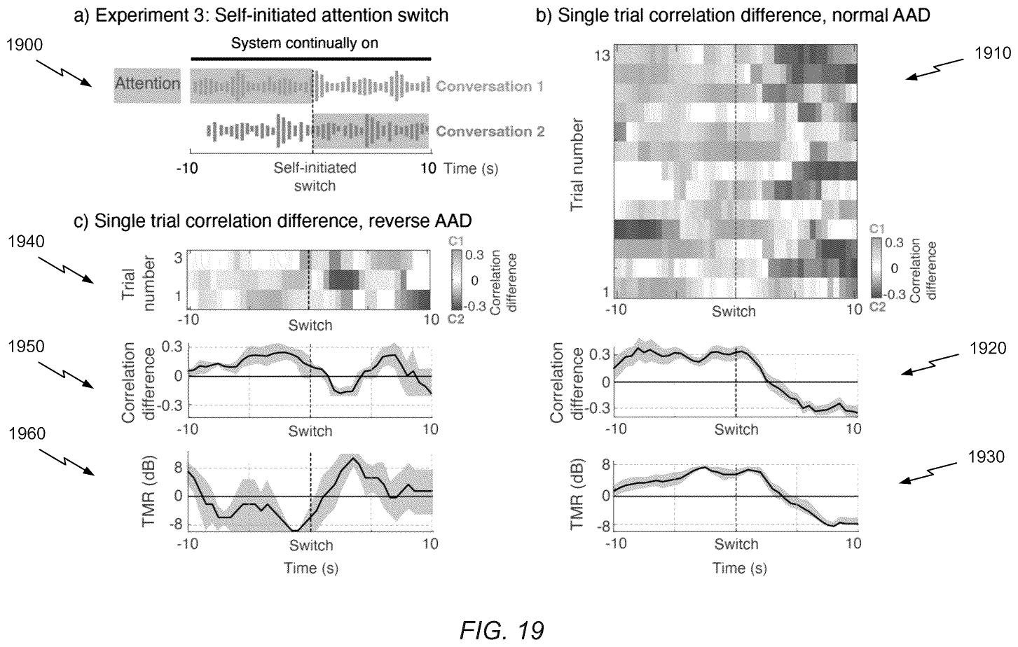

Experiment 3 tested self-initiated attention switching. In natural listening environments, attention shifts are often internally driven rather than externally cued. This experiment tested whether the AAD system could decode and enhance the attended conversation when subjects freely switched attention between two competing talkers without explicit instruction. Diagram 1900 of FIG. 19 illustrates the experimental set up implemented for Experiment 3, in which participants freely shifted their attention between two competing conversations without external cues, while the system continuously decoded and enhanced the attended speech in real time.

Unlike the previous experiment, where subjects were visually cued to switch, here they were allowed to self-initiate attention shifts at any time while the system continuously tracked their neural responses and adjusted the gain(s) accordingly. To provide a reference for analysis, subjects indicated their attentional focus by pointing to the loudspeaker they were attending to, allowing for segmentation of the data based on voluntary attention shifts. The results demonstrate that AAD effectively tracked voluntary attention shifts and dynamically adjusted the enhancement of the attended conversation in real time. As shown in graphs 1910, 1920, and 1930, correlation differences between the reconstructed and actual speech envelopes revealed clear transitions between attended conversations, consistent with the subject's self-reported shifts. Additionally, the target-to-masker ratio (TMR) adapted in real time to match the decoded attentional state, ensuring that the newly attended conversation was amplified while the previously attended one was attenuated. These findings indicate that real-time AAD enables natural, self-directed auditory attention modulation without requiring external cues.

To further evaluate system performance, an additional control experiment was conducted, in which the gain control was intentionally reversed without informing the subject. In this condition, the system suppressed the attended conversation and enhanced the unattended one. This disrupted neural tracking and TMR alignment, confirming that proper decoding is necessary for effective attention-based enhancement. The subjects immediately reported a different experience and found it difficult to hear the intended conversation. This control underscores the importance of accurate attention decoding for a positive user experience and highlights the robustness of AAD-driven speech enhancement. Graphs 1940, 1950 and 1960 of FIG. 19 include the experimental results for the reverse AAD scenario. The shaded error bars in the graphs 1920, 1930, 1950, and 1960 indicate the standard error of the mean.

Following the experiment, subjects were debriefed on the system's functionality and their experiences with self-directed attention switching. Participants reported that they could freely shift focus between conversations and that the system's adaptive gain control felt natural and intuitive. Notably, the participants consistently perceived the enhanced talker as aligning with their intended focus, reinforcing the impression that AAD accurately tracked their attentional state. In post-experiment discussions, subjects described the attention tracking as seamless, noting that speech enhancement occurred without noticeable delay or effort. All four subjects expressed enthusiasm about the potential of this technology to improve hearing in crowded environments, highlighting its promise for real-world applications.

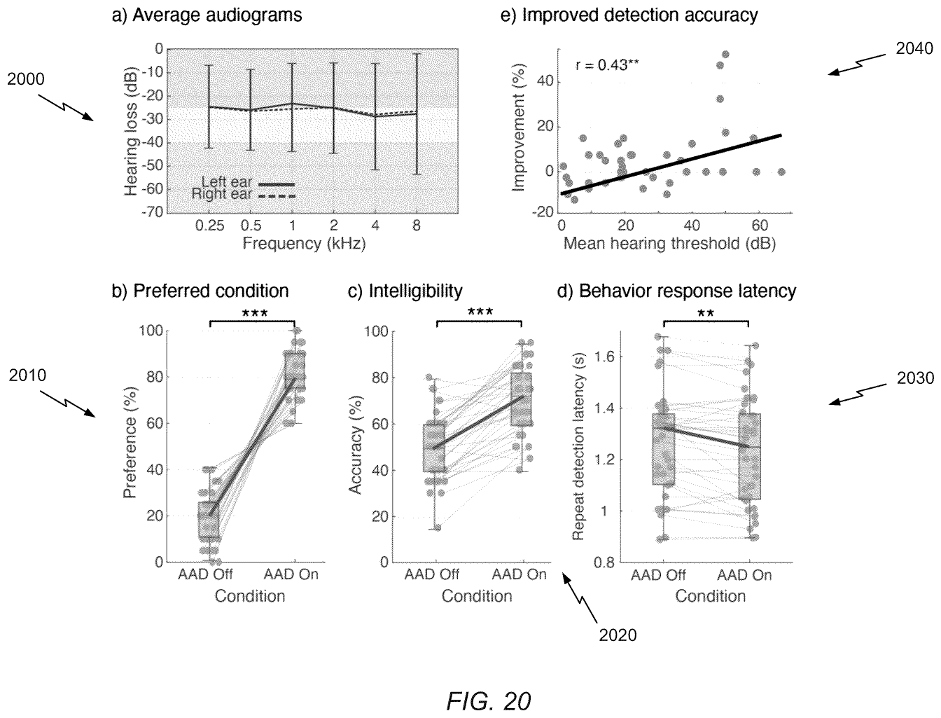

To assess whether AAD provides benefits for individuals with hearing loss, a web-based psychophysics experiment was conducted with 40 hard-of-hearing participants. Since the iEEG participants in the study had normal hearing, this follow-up experiment evaluated whether speech enhanced by AAD, based on those participants' neural responses, could improve intelligibility and reduce listening effort for hard-of-hearing listeners. Audiograms confirmed a wide range of hearing loss profiles across participants in the HL group. More particularly, FIG. 20 includes graphs illustrating evaluation results for real-time closed-loop auditory attention decoding (AAD) by individuals with hearing impairment. Graph 2000 provides the average audiograms of participants, showing varying degrees of hearing loss across frequencies (error bars indicate standard deviation). Each participant was assigned to one of four groups (n=10 per group), with each group evaluating AAD-enhanced audio derived from a different iEEG participant's trials. The task mirrored Experiment 1 and had participants listening to spatialized AAD-processed audio over earphones and following a cued conversation. The participants performed the same repeated word detection task, rated which segment (System On vs. System Off) was easier to follow, and answered intelligibility questions.

Box plots 2010-2030 present the evaluation results determined for this part of the study. For each of the box plots, the center line represents the median, the box limits represent the upper and lower quartiles, the whiskers represent the minimum and maximum values, and the individual points correspond to the subjects (n=40). The box plots 2010 of FIG. 20 illustrates the participants' preferred listening condition, with most participants preferring speech during AAD on condition over AAD off. The graph 2020 illustrates the participants' rating of intelligibility with respect to the listening conditions. Participants performed better in comprehension questions when listening to speech enhanced by AAD compared to when AAD was off. The box plot 2030 illustrates the participants' behavioral response latency. Participants responded faster to repeated words when AAD was on, suggesting reduced cognitive effort in tracking speech. Graph 2040 illustrates improvement in detection accuracy. The improvement in repeat detection accuracy was significantly correlated with the degree of hearing loss, indicating that individuals with greater hearing impairment benefited more from AAD.

As shown in the box plots graphs 2010-2030, AAD provided significant perceptual benefits for listeners with hearing loss. Participants strongly preferred the System On condition over System Off (in the graph 2010, for the two sided paired t-test, t(39)=−17.53, p<0.001, Cohen's d=2.77,). Additionally, speech intelligibility as measured by performance on the comprehension task improved (in the box plot 2020, for the two-sided paired t-test, t(39)=9.50, p<0.001, Cohen's d=2.77), and repeat detection latency was significantly lower with AAD (in the graph 2030, for the two-sided paired t-test, t(39)=3.32, p=0.0019, Cohen's d=0.53), indicating reduced listening effort.

To determine whether AAD's benefit scaled with hearing impairment severity, the correlation between hearing loss (average of audiogram across frequencies) and speech detection improvement was analyzed. As shown in the graph 2040, participants with greater hearing loss exhibited larger improvements in detection accuracy (r(38)=0.43, p=0.0054), suggesting AAD is particularly beneficial for those with more severe impairments. These results support AAD as a promising assistive hearing technology, particularly for individuals with significant hearing deficits.

The framework and results discussed with respect to FIGS. 12-20 provide the first direct behavioral evidence that real-time closed-loop auditory attention decoding (AAD) can enhance speech perception in challenging multi-talker environments. By demonstrating that neural signals can be used not only to decode attentional focus in real time, but also to improve intelligibility and reduce listening effort, the results move AAD from theoretical promise to practical potential. By evaluating perception across instructed and self-directed attention-switching scenarios, it was demonstrated that AAD can flexibly adapt to natural changes in listener focus which is critical for real-world usability. It was further shown that hearing-impaired individuals benefit from AAD processed audio, underscoring the translational relevance of this approach.

As described herein, a simple linear decoding model was employed, which proved sufficient due to the high signal-to-noise ratio of iEEG recordings. However, nonlinear and end-to-end decoding approaches, particularly in lower-SNR modalities such as EEG, are possible. These methods may offer a path toward closing the performance gap between invasive and non-invasive recordings. Indeed, theoretical work has shown that current decoding methods do not yet approach the upper bounds of AAD performance, suggesting that further algorithmic and technological advances (e.g., in terms of the performance of electrodes to record neural signals) could yield meaningful improvements. Note also that successful decoding of auditory attention does not require full intelligibility of the speech signal. Prior research has shown that neural tracking of the attended talker persists even when intelligibility is severely degraded. This allows AAD to function effectively and improve speech perception even when the listener cannot fully understand the speech, a condition often encountered in individuals with hearing loss.

The practical implementation of real-time AAD systems will also need to carefully balance speech enhancement with environmental awareness. The study's findings suggest that an approximate gain adjustment of 6 dB in target-to-masker ratio significantly improves intelligibility without fully isolating the listener from the acoustic environment. Real-world applications, such as crowded public spaces or dynamic social gatherings, will inevitably introduce additional complexities, including non-speech sounds and unpredictable attention shifts. Addressing these challenges through further experimental and computational refinement will be important for real-world deployment.

The approaches described herein also open broader avenues for integrating cognitive states into assistive hearing technologies, shifting the paradigm from passive sound amplification to active, intent driven auditory enhancement. Future research might explore incorporating other cognitive signals, such as listener intention, effort, and context-based attentional signals, leveraging advanced AI frameworks to achieve deeper integration between cognitive neuroscience and machine listening.

In summary, the framework discussed herein establishes a foundation for the development of next-generation assistive and augmentative auditory technologies. The study's findings demonstrate that cognitively driven systems can improve communication for individuals with hearing impairments while also enhancing auditory performance in normal-hearing users navigating complex acoustic environments. By implementing systems that enhance perception based on cognitive intent, the proposed approaches provide a principled framework for developing and implementing smart hearing devices that align dynamically with user goals.

As discussed above, the offline stage of the proposed framework implementations may include identifying speech-responsive electrodes based on neural activity recorded and analyzed during the offline phase. High-gamma power (70-150 Hz) was extracted from each electrode, and t-tests were performed to compare activity during speech versus silence. Based on this analysis, the number of speech-responsive electrodes used in subsequent analyses was: S1: 48, S2: 38, S3: 42, and S4: 21.

During the offline phase, neural data was recorded while subjects selectively attended to a cued speaker, allowing the AAD model to be trained to decode attentional focus. In the online phase, the trained AAD model was deployed to analyze brain signals in real time, decode the attended conversation, and selectively enhance it in a closed-loop manner. During the testing and evaluation for both phases, subjects listened to two concurrent conversations with background noise, presented through two external speakers. The speech streams were spatially separated, with one conversation played from the left speaker (−15° azimuth) and the other from the right speaker (+15° azimuth). A task presentation laptop (e.g., the laptop 1223 in FIG. 12), positioned centrally between the speakers, displayed a visual cue (arrow) indicating which conversation to attend to. To facilitate engagement, the cued conversation began three seconds before the interfering conversation.

Each speech stream was a conversation between two talkers, taking turns to discuss everyday topics, such as food, exercise, and travel. The dialogues were scripted and recorded by professional voice actors to ensure naturalistic yet controlled stimuli. To monitor behavioral performance, a 1-back task was implemented. Repeated words were inserted into both conversations, and subjects were instructed to press a button whenever they detected a repeated word in the attended speech. This ensured compliance with attentional instructions. Two types of diotic background noise, pedestrian noise and babble noise, were randomly assigned across trials. The background noise level was set 15 dB lower than the target speech in trials where both conversations were presented at equal intensity (0 dB target-to-masker ratio). This noise level remained constant throughout both the offline and online phases. In addition to behavioral responses, neural data and pupillometry were recorded.

The offline phase was conducted to collect training data for an auditory attention decoding model to be deployed in the online phase. In a real-time closed-loop AAD system, the listener may experience both positive and negative talker-to-masker ratios (TMRs). A positive TMR occurs when the system correctly amplifies the attended talker, while a negative TMR occurs when the system enhances the incorrect talker or during the brief period following an attention switch. To ensure that the model generalizes well for both conditions, the offline phase incorporated a range of positive, negative, and neutral TMR settings. The offline phase included 26 trials, each lasting 38 seconds. A progress bar was displayed to indicate trial progression, and each trial was divided into two segments: the first from 10 to 24 seconds, and the second from 24 to 38 seconds. The current segment number, as the trial progressed, was highlighted on the screen. To ensure balanced exposure to different TMR conditions, trials were randomized across three conditions. Ten (10) trials began with a negative TMR of −6 dB, followed by a positive TMR of +9 dB. Ten trials began with a positive TMR of +9 dB, followed by a negative TMR of −6 dB. Six (6) trials maintained a 0 dB TMR throughout. At the start of each trial, a visual arrow cued the attended conversation (left or right), and speech began three seconds later. Subjects were instructed to track repeated words in the cued conversation by pressing a button, as described earlier. For trials involving TMR switches, participants were also asked to report which segment was more difficult to follow using a forced-choice response.

The auditory attention decoding (AAD) model trained during the offline phase was deployed to decode and enhance the attended conversation in real time during the online phase. Subjects were initially informed that this phase was a continuation of the offline phase but were not made aware that their neural activity was being used to actively control the system, ensuring a blinded experimental design. The online phase included two types of trials: binary forced-choice trials (Experiment 1) and attention switch trials (Experiment 2). In the binary forced-choice trials (n=20), subjects completed a task similar to the offline phase, with trials divided into two segments. In Part 1, the AAD model passively ran in the background, but the target-to-masker ratio (TMR) remained fixed at −6 dB, meaning the system did not enhance the attended conversation. In Part 2, the closed-loop system was activated, dynamically enhancing the target talker's voice up to +9 dB TMR. At the end of each trial, subjects rated which segment was easier to follow and answered two intelligibility questions, each with four possible answers. As in the offline phase, subjects tracked repeated words in the cued conversation. In attention switch trials (n=10), subjects were instructed to shift their focus between talkers. Each trial lasted 38 to 47 seconds, with a visual cue (arrow) displayed continuously on the screen. At a predetermined time, midway through the trial, the cue flipped direction, signaling subjects to switch their attention. Speech began at 0 dB TMR, and closed-loop feedback was activated five seconds into the trial to allow the system to adapt.

At the end of the online phase, subjects were debriefed and informed that their brain activity had actively controlled speech enhancement in real time. They were asked about their experience and whether they would consider using such a system in real-world listening conditions. If a subject expressed interest and time permitted, they were allowed to interact with the system without visual cues, freely switching between conversations at will (Experiment 3). During these self-initiated switching trials, the system's gain control was secretly reversed in some cases, amplifying the unattended talker while suppressing the attended one. This control experiment tested whether subjects would notice a difference in speech clarity and listening effort when the system functioned incorrectly.

During the evaluation and testing of the implementations described herein, offline data acquisition, pre-processing, and model training were performed as follows. Neural data was recorded using Tucker-Davis Technologies (TDT) hardware for subjects S1-S3 and Ripple Grapevine Trek for S4. The hardware simultaneously captured neural activity, audio stimulus data, and behavioral button presses, ensuring precise synchronization. After acquisition, neural signals were pre-processed to extract high-gamma (70-150 Hz) and low-frequency (0.5-30 Hz) envelopes from speech-responsive electrodes. The speech envelopes of the two conversation streams (without background noise) were extracted in real time by the recording hardware, computed by taking the absolute value of the waveform and filtering it between 0.5-12 Hz. All data were epoched into trials and normalized.

Subject-specific AAD models were developed using a linear stimulus reconstruction approach. These models were trained to reconstruct the envelope of the attended conversation by leveraging high-gamma and low-frequency neural features from speech-responsive electrodes. The conversation with the highest correlation to the reconstructed envelope was identified as the attended talker. A 400 ms receptive field was applied to the neural data, and model performance was evaluated using leave-one-trial-out cross-validation.

The experiments also evaluated how well auditory attention can be decoded using individual electrodes. For this analysis, the process described above was repeated using offline data and trained an AAD model using each speech-responsive electrode independently. Specifically, both the high-gamma and low-frequency envelopes from a given electrode were used to reconstruct the envelope of the attended speech, and the resulting AAD accuracy was then computed. These results (for a 4-second window) are shown in graph 1500 of FIG. 15.

Building on this, the study assessed how AAD performance improves as the number of electrodes increases. To do this, a forward selection approach was employed. First, the single best electrode was identified, i.e., the electrode yielding the highest AAD accuracy using a 4-second window. Then, keeping this electrode fixed, all remaining electrodes were iteratively evaluated to identify the second best. This process was repeated by adding one electrode at a time, each time selecting the electrode that provided the highest incremental improvement in accuracy, until all relevant electrodes were considered for each subject. The AAD accuracies as a function of the top N electrodes (for a 4-second window) are summarized in FIG. 16.

During the online phase, two synchronized PCs running MATLAB were used for real-time decoding and stimulus presentation. The first PC, connected to the acquisition hardware, recorded neural data and streamed it in real time along with the speech envelopes of both conversations to a local MATLAB instance. This MATLAB instance processed the neural signals, extracting high-gamma (70-150 Hz) and low-frequency (0.5-30 Hz) envelopes from speech responsive electrodes. Then, the AAD model estimated the attended conversation by reconstructing the attended speech envelope from neural activity. The reconstructed envelope was then correlated with the envelopes of the left and right speech streams. The difference in correlation determined attentional focus: a positive difference indicated attention to the left conversation, while a negative difference indicated attention to the right. Correlations were computed using a 4-second sliding window with a 0.5-second hop size, yielding outputs at 2 Hz, which were smoothed using a third-order median filter. The filtered outputs were transmitted via Ethernet to the second PC for stimulus presentation. The second PC controlled the gain of the competing speech streams using MATLAB's Real-Time Audio Toolbox. Gain adjustments followed a 5-state Markov chain. All trials began in a neutral baseline state (state 3). The first and fifth states represented maximum enhancement of the right and left conversations, respectively. In state 5, the left conversation was amplified by +9 dB over the right, while in state 1, the right conversation was amplified by +9 dB over the left. A positive correlation difference shifted the system toward state 5, amplifying the left speaker, while a negative correlation difference shifted it toward state 1, amplifying the right speaker. To ensure consistent overall audio power, individual conversation gains were dynamically adjusted across states. For trials with an initial non-zero TMR (e.g., binary forced-choice trials), the system was initialized in state 3, with power levels interpolated between state 1 and state 5. This design allowed smooth, real-time gain adjustments, ensuring natural and dynamic auditory enhancement while preserving consistent total power across all states.

Lastly, as noted, pupillometry, which is the measurement of pupil size, is a well-established indicator of listening effort in auditory experiments. Smaller pupil dilations are associated with reduced cognitive load, while larger dilations reflect increased effort. In the context of AAD-driven speech enhancement, it was hypothesized that pupil dilation would be smaller when the system successfully enhanced the attended speech (+ve TMR) compared to when it was off (−ve TMR), indicating reduced listening effort. Pupil dilation was recorded using a Tobii Pro Nano eye tracker with a sampling rate of 60 Hz, positioned at chin level beneath the display screen. Pupil size was baseline-corrected for each trial by computing the mean dilation one second before trial onset and rescaling the raw pupil data accordingly. Left and right pupil streams were averaged and aligned to the trial audio for analysis. Valid pupillometry data was successfully collected for S2 and S3 across 20 binary forced-choice trials. Data for S1 and S4 were excluded due to tracking limitations caused by subject positioning.

With reference again to FIG. 11, in some embodiments, processing one or more of the plurality of separated signals (as performed at block 1140 of FIG. 11) can further include deriving an estimated speech envelope from a low frequency band and a high frequency band of the neural signals, with the low frequency band and the high frequency band being non-contiguous (i.e., there is, in such embodiments, a middle band, flanked by the low and high frequency bands, that is removed). The processing of the one or more plurality of separated signals further includes selecting the one of the plurality of separated signals based on a comparison of the estimated speech envelope to respective speech envelopes derived for the plurality of separated signals (e.g., to determine similarity between the envelopes, or computing some correlation or distance measure between the estimated envelope and the actual speech envelopes). In various examples, deriving the estimated speech envelope may include applying a speech envelope reconstruction machine learning system, trained to predict speech envelopes based on neural signal frequency band inputs, to the low frequency band and the high frequency band of the obtained neural signals. Such a machine learning system may have been trained through use of ground truths samples that include measured neural signal responses and actual speech envelopes that resulted in the measured neural signal responses. The training can also include optimizing coefficients of the machine learning system so that when runtime frequency band information (e.g., low and high frequency bands of measured neural signals) is provided to the machine learning system, the system will produce a predicted output representative of an estimated speech envelope. It is noted that other techniques (e.g., algorithmic processes) may be used to transform neural signals information into estimated speech envelopes.

In some embodiments, processing one or more of the plurality of separated signals (at block 1140 of FIG. 11) may include performing closed-loop processing on the one of the plurality of separated signals and the neural signals to track attention of the person by continually modulating amplitudes of each of the plurality of separated signals based on the neural signals obtained at a first time instance to cause a change to the respective amplitudes of each of the plurality of separated sound signals that cause a resultant change, at a second time instance, to subsequent neural signals for the person to allow real-time attention switching by the person.

Performing the various techniques and operations described herein may be facilitated by a controller device(s) (e.g., a processor-based computing device). Such a controller device may include a processor-based device such as a computing device, and so forth, that typically includes a central processor unit or a processing core. The device may also include one or more dedicated learning machines (e.g., neural networks) that may be part of the CPU or processing core. In addition to the CPU, the system includes main memory, cache memory and bus interface circuits. The controller device may include a mass storage element, such as a hard drive (solid state hard drive, or other types of hard drive), or flash drive associated with the computer system. The controller device may further include a keyboard, or keypad, or some other user input interface, and a monitor, e.g., an LCD (liquid crystal display) monitor, that may be placed where a user can access them.

The controller device is configured to facilitate, for example, sound/speech processing operations based on neural signals collected from a person (listener), audio signals collected from an acoustic scene, and spatial information associated with the audio signals in the acoustic scene. The storage device may thus include a computer program product that when executed on the controller device (which, as noted, may be a processor-based device) causes the processor-based device to perform operations to facilitate the implementation of procedures and operations described herein. The controller device may further include peripheral devices to enable input/output functionality. Such peripheral devices may include, for example, flash drive (e.g., a removable flash drive), or a network connection (e.g., implemented using a USB port and/or a wireless transceiver), for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), an ASIC (application-specific integrated circuit), a DSP processor, a graphics processing unit (GPU), application processing unit (APU), etc., may be used in the implementations of the controller device. Other modules that may be included with the controller device may include a user interface to provide or receive input and output data. The controller device may include an operating system.

The machine learning systems used in the implementations described herein may be realized using different types of ML architectures, configurations, and/or implementation approaches. For example, neural networks used within the proposed frameworks may include convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), vector transformation ML systems, etc. The various learning processes implemented through use of the neural networks may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, etc.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

In some embodiments, any suitable computer readable media can be used for storing instructions for performing the processes/operations/procedures described herein. For example, in some embodiments computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only Memory (EEPROM), etc.), any suitable media that is not fleeting or not devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method for sound processing comprising:
obtaining, by a device, sound signals from two or more sound sources in an acoustic scene in which a person is located;
applying, by the device, speech-separation processing to the sound signals from the two or more sound sources to derive a plurality of separated signals that each contains signals corresponding to different groups of the two or more sound sources, wherein the two or more sound sources are associated with spatial information;
obtaining, by the device, neural signals for the person, the neural signals being indicative of one of the two or more sound sources the person is attentive to; and
processing one or more of the plurality of separated signals selected based on the obtained neural signals, the plurality of separated signals, and the spatial information.

2. The method of claim 1, wherein applying the speech separation processing comprises:
separating the sound signals according to a time-domain audio separation network approach implemented with an encoder-decoder architecture.

3. The method of claim 2, wherein separating the sound signals comprises:
processing two or more channels of mixed sound signals produced by the two or more moving sound sources by respective linear encoder transforms to produce resultant 2-D representations of the mixed sound signals;
filtering the resultant 2-D representations of the mixed sound signals and a representation of the spatial information using a series of temporal convolutional network (TCN) blocks to estimate multiplicative masks;
applying the estimated multiplicative masks to the resultant 2-D representations of the mixed sound signals to derive masked representations of separated sound signals for the two or more channels; and
filtering the masked representations of the separated sound signals using a linear decoder transform to derive separated waveform representations for different groups of talkers from the two or more sound sources.

4. The method of claim 3, wherein the series of temporal convolutional network (TCN) blocks comprises multiple repeated stacks that each includes one or more 1-D convolutional blocks.

5. The method of claim 3, further comprising:
performing post-separation enhancement filtering to suppress noisy features, including:
processing the mixed sound signals and the separated sound signals with respective linear encoder transforms to produce resultant 2-D post-enhancement representations;
filtering the resultant 2-D post enhancement representations using a series of post-enhancement temporal convolutional network (TCN) blocks to estimate post-enhancement multiplicative masks;
applying the estimated post-enhancement multiplicative masks to the resultant 2-D representations of the mixed sound signals to derive masked representations for the two or more channels;
summing the masked representations for the two or more channels to obtain a summed masked representation; and
filtering the summed masked representation using a linear decoder transform.

6. The method of claim 1, further comprising:
determining the spatial information associated with the two or more sound sources.

7. The method of claim 6, wherein determining the spatial information associated with the two or more sound sources comprises:
deriving sound-based estimated trajectories of the two or more sound sources in the acoustic scene.

8. The method of claim 6, wherein determining the spatial information comprises:
deriving one or more of: inter-channel phase differences (IPDs) between a first sound signal captured at a first microphone for one ear of the person and a second sound signal captured at a second microphone for another ear of the person, or an inter-channel level differences (ILD's) between the first sound signal and the second sound signal.

9. The method of claim 1, wherein processing one or more of the plurality of separated signals comprises:
performing canonical correlation analysis based on the neural signal representations, estimated trajectory representations of the two or more sound sources, and the plurality of separated signals, to identify an attended speaker.

10. The method of claim 9, wherein performing the canonical correlation analysis comprises:
applying a machine learning canonical correlation analysis model to machine learning model input data derived from the neural signal representations, the estimated trajectory representations, and the plurality of separated signals.

11. The method of claim 1, wherein obtaining the neural signals for the person comprises:
obtaining the neural signals according to one or more of: electrocorticography (ECoG) recordings, invasive intracranial electroencephalography (iEEG) recordings, non-invasive electroencephalography (EEG) recordings, functional near-infrared spectroscopy (fNIRS) recordings, minimally-invasive neural recordings, ear electroencephalography (EEG) recordings, recordings captured with stentrodes, or recordings captured with subdural or brain-implanted electrodes.

12. The method of claim 1, wherein processing one or more of the plurality of separated signals comprises performing one or more of:
amplifying the at least the one of the plurality of separated signals, or
attenuating at least another of the plurality of separated signals.

13. The method of claim 1, wherein processing one or more of the plurality of separated signals further comprises:
deriving an estimated speech envelope from a low frequency band and a high frequency band of the neural signals, the low frequency band and the high frequency band being non-contiguous; and
selecting the one of the plurality of separated signals based on a comparison of the estimated speech envelope to respective speech envelopes derived for the plurality of separated signals.

14. The method of claim 13, wherein deriving the estimated speech envelope comprises:
applying a speech envelope reconstruction machine learning system, trained to predict speech envelopes based on neural signal frequency band inputs, to the low frequency band and the high frequency band of the obtained neural signals.

15. The method of claim 1, wherein processing one or more of the plurality of separated signals comprises:
performing closed-loop processing on the one of the plurality of separated signals and the neural signals to track attention of the person by continually modulating amplitudes of each of the plurality of separated signals based on the neural signals obtained at a first time instance to cause a change to the respective amplitudes of each of the plurality of separated sound signals that cause a resultant change, at a second time instance, to subsequent neural signals for the person to allow real-time attention switching by the person.

16. The method of claim 1, wherein processing one or more of the plurality of separated signals comprises:
performing auditory attention decoding based on the neural signal representations, estimated trajectory representations of the two or more sound sources, and the plurality of separated signals, to identify an attended speaker.

17. A sound processing system comprising:
at least one microphone to obtain sound signals from two or more sound sources in an acoustic scene in which a person is located;
one or more neural sensors to obtain neural signals for the person, the neural signals being indicative of one of the two or more sound sources the person is attentive to; and
a controller coupled to the at least one microphone and the one or more neural sensors, the controller configured to:
apply speech-separation processing to the sound signals from the two or more sound sources to derive a plurality of separated signals that each contains signals corresponding to different groups of the two or more sound sources, wherein the plurality of separated signals are associated with spatial information; and
process one or more of the plurality of separated signals selected based on the obtained neural signals, the plurality of separated signals, and the spatial information.

18. The system of claim 17, wherein the controller configured to apply the speech separation processing is configured to separate the sound signals according to a time-domain audio separation network approach implemented with an encoder-decoder architecture, including to:
process two or more channels of mixed sound signals produced by the two or more moving sound sources by respective linear encoder transforms to produce resultant 2-D representations of the mixed sound signals;
filter the resultant 2-D representations of the mixed sound signals and a representation of the spatial information using a series of temporal convolutional network (TCN) blocks to estimate multiplicative masks;
apply the estimated multiplicative masks to the resultant 2-D representations of the mixed sound signals to derive masked representations of separated sound signals for the two or more channels; and
filter the masked representations of the separated sound signals using a linear decoder transform to derive separated waveform representations for different groups of talkers from the two or more sound sources.

19. The system of claim 17, wherein the controller is further configured to:
determine the spatial information associated with the two or more sound sources, including to derive sound-based estimated trajectories of the two or more sound sources in the acoustic scene.

20. The system of claim 19, wherein the controller configured to determine the spatial information is configured to:
derive one or more of, for example, inter-channel phase differences (IPDs) between a first sound signal captured at a first microphone for one ear of the person and a second sound signal captured at a second microphone for another ear of the person, and/or an inter-channel level differences (ILD's) between the first sound signal and the second sound signal.

21. The system of claim 17, wherein the controller configured to process one or more of the plurality of separated signals is further configured to:
derive an estimated speech envelope from a low frequency band and a high frequency band of the neural signals, the low frequency band and the high frequency band being non-contiguous; and
select the one of the plurality of separated signals based on a comparison of the estimated speech envelope to respective speech envelopes derived for the plurality of separated signals.

22. The system of claim 17, wherein the controller configured to process one or more of the plurality of separated signals is further configured to:
perform closed-loop processing on the one or more of the plurality of separated signals and the neural signals to track attention of the person by continually modulating amplitudes of each of the plurality of separated signals based on the neural signals obtained at a first time instance to cause a change to the respective amplitudes of each of the plurality of separated sound signals that cause a resultant change, at a second time instance, to subsequent neural signals for the person to allow real-time attention switching by the person.

23. A non-transitory computer readable media comprising computer instructions executable on a processor-based device to:
obtain sound signals from two or more spatially separated, sound sources in an acoustic scene in which a person is located;
apply speech-separation processing to the sound signals from the two or more sound sources to derive a plurality of separated signals that each contains signals corresponding to different groups of the two or more sound sources, wherein the two or more sound sources are associated with spatial information;
obtain neural signals for the person, the neural signals being indicative of one of the two or more sound sources the person is attentive to; and
process one or more of the plurality of separated signals selected based on the obtained neural signals, the plurality of separated signals, and the spatial information.
